(19) United States
(12) Patent Application Publication
(10) Pub. No.: US 2018/0089712 A1
(43) Pub. Date: Mar. 29, 2018

(54) INFORMATION PROCESSING DEVICE, INFORMATION PROCESSING METHOD, AND INFORMATION PROCESSING PROGRAM

(71) Applicant: Rakuten, Inc., Tokyo (JP)

(72) Inventor: Yasuharu WATANABE, Tokyo (JP)

(73) Assignee: Rakuten, Inc., Tokyo (JP)

(21) Appl. No.: 15/563,234

(22) PCT Filed: Mar. 31, 2015
(86) PCT No.: PCT/JP2015/060174

§ 371 Date: Sep. 29, 2017

(51) Int. Cl. G06Q 30/02

(52) U.S. Cl. CPC G06Q 30/0224; G06Q 30/0201; G06Q 30/0215

(57) ABSTRACT

An information processing device identifies an item for which an electronic coupon is to be issued and a user to which the electronic coupon is to be issued. The information processing device then identifies the plurality of electronic coupon resources that are associated with at least either the identified item or the identified user, among a plurality of electronic coupon resources that are available as financial resources for a value corresponding to a privilege of the electronic coupon. Based on the identified plurality of electronic coupon resources, the information processing device determines the allocation of electronic coupon resources to the value corresponding to the privilege of the electronic coupon. The information processing device then issues, to the identified user, an electronic coupon indicating the privilege corresponding to the total amount of contributions to be contributed from the electronic coupon resources, based on the determined allocation.

### TECHNICAL FIELD

The present invention relates to techniques, including systems, for issuing an electronic coupon indicating a privilege available in payment for item transactions.

### BACKGROUND ART

A system that issues electronic coupons, such discount coupons, is conventionally known. For example, Patent Literature 1 discloses a system that issues a discount coupon for any item, based on coupon information including information about a discount. This system can change settings, such as a discount, included in coupon information in real time. This coupon information causes a coupon issuing device to issue coupons.

### CITATION LIST

### Patent Literature

Patent Literature 1: JP 2010-218483 A

### SUMMARY OF INVENTION

### Technical Problem

A privilege of an electronic coupon, such as a discount, is paid for from a plurality of electronic coupon resources (budgets) that are prepared, for example, by stores that sell items, manufacturers that manufacture items, and a site operator that provides a shopping mall site over the Internet. However, in the conventional art, it has not been so easy to quickly and flexibly determine the allocation of electronic coupon resources, from which the privilege of the electronic coupon is paid for, depending on an item for which and a user (who wishes to purchase the item) to which the electronic coupon is to be issued.

Therefore, it is an object of the present invention to provide an information processing device, an information processing method, and an information processing program that are capable of quickly and flexibly determining the allocation of electronic coupon resources, depending on an item for which and a user to which an electronic coupon is to be issued.

### Solution to Problem

To solve the above problem, the invention according to claim 1 includes target item identifying means, target user identifying means, financial resource identifying means, determining means, and issuing means. The target item identifying means identifies an item for which an electronic coupon is to be issued, the electronic coupon indicating a privilege available in payment for item transactions. The target user identifying means identifies a user to which the electronic coupon is to be issued. The financial resource identifying means identifies a plurality of electronic coupon resources that are available as financial resources for a value corresponding to a privilege of the electronic coupon. The plurality of electronic coupon resources are associated with at least either the item identified by the target item identifying means or the user identified by the target user identifying means. Based on the plurality of electronic coupon resources identified by the financial resource identifying means, the determining means determines the allocation of the electronic coupon resources to the value corresponding to the privilege of the electronic coupon. The issuing means issues, to the user identified by the target user identifying means, an electronic coupon indicating the privilege corresponding to the total amount of contributions to be contributed from the electronic coupon resources, based on the allocation determined by the determining means.

This invention enables the allocation of electronic coupon resources to be quickly and flexibly determined, depending on an item for which and a user to which an electronic coupon is to be issued.

The invention according to claim 2 is the information processing device according to claim 1 in which the electronic coupon resources are associated one-to-one with a plurality of providing entities that provide the item identified by the target item identifying means. The information processing device further includes user counting means and calculating means. The user counting means identifies, for each providing entity, the number of potential users of the providing entity. The calculating means calculates, for each providing entity, an electronic coupon resource per predetermined unit number of users, based on the number of users of each providing entity identified by the user counting means. The electronic coupon resource remains after contribution of a predetermined amount. The determining means preferentially allocates the electronic coupon resources whose electronic coupon resource per the predetermined unit number calculated by the calculating means is relatively large.

This invention enables a fair allocation of electronic coupon resources even when there is a wide difference in initial total budget between the electronic coupon resources.

The invention according to claim 3 is the information processing device according to claim 1 in which the electronic coupon resources are associated one-to-one with a plurality of providing entities that provide the item identified by the target item identifying means. The information processing device further includes item counting means and calculating means. The item counting means identifies, for each providing entity, the number of items whose transactions are expected to be closed, in the stock quantity of the item for which the electronic coupon is to be issued. The calculating means calculates, for each providing entity, an electronic coupon resource per predetermined unit number of the items, based on the number of items of each providing entity identified by the item counting means. The determining means preferentially allocates the electronic coupon resources whose electronic coupon resource per the predetermined unit number calculated by the calculating means is relatively large.

This invention enables a fair allocation of electronic coupon resources even when there is a wide difference in initial total budget between the electronic coupon resources.

The invention according to claim 4 is the information processing device according to any one of claims 1 to 3 in which the plurality of electronic coupon resources are each distributed among item categories. The determining means preferentially allocates the electronic coupon resources having a relatively large amount of electronic coupon resource distributed to an item category to which the item for which the electronic coupon is to be issued belongs.

This invention allows for more efficient use of electronic coupon resources depending on which item category an item for which an electronic coupon is to be issued belongs to.

The invention according to claim 5 is the information processing device according to any one of claims 1 to 3 in which the plurality of electronic coupon resources are each distributed among predetermined user bases The determining means preferentially allocates the electronic coupon resources having a relatively large amount of electronic coupon resource distributed to a user base to which the user to which the electronic coupon is to be issued belongs.

This invention allows for more efficient use of electronic coupon resources depending on which user base a user to which an electronic coupon is to be issued belongs to.

The invention according to claim 6 is the information processing device according to claim 4 in which more of the electronic coupon resources are distributed to an item category having a relatively high expectation that item transactions are expected to be closed, among the item categories.

This invention makes it possible to increase contributions from electronic coupon resources corresponding to item categories having a relatively high expectation that item transactions are expected to be closed, and accordingly to assist in closing transactions of items that belong to the item categories.

The invention according to claim 7 is the information processing device according to claim 5 in which more of the electronic coupon resources are distributed to a user base having a relatively high expectation that item transactions are expected to be closed, among the user bases.

This invention makes it possible to increase contributions from electronic coupon resources corresponding to user bases having a relatively high expectation that item transactions are expected to be closed, and accordingly to assist in closing transactions by users who belong to the user bases.

The invention according to claim 8 is the information processing device according to claim 4 in which more of the electronic coupon resources are distributed to an item category in which electronic coupons issued in the past are used at a relatively high rate, among the item categories.

This invention makes it possible to increase contributions from electronic coupon resources corresponding to item categories in which electronic coupons issued in the past are used at a relatively high, and accordingly to assist in closing transactions of items that belong to the item categories.

The invention according to claim 9 is the information processing device according to claim 5 in which more of the electronic coupon resources are distributed to a user base that uses electronic coupons issued in the past at a relatively high rate, among the user bases.

This invention makes it possible to increase contributions from electronic coupon resources corresponding to user bases that use electronic coupons issued in the past at a relatively high, and accordingly to assist in closing transactions by users who belong to the user bases.

The invention according to claim 10 is the information processing device according to claim 4 in which more of the electronic coupon resources are distributed to an item category having a relatively high return on investment based on item prices or discount amounts, among the item categories.

This invention makes it possible to increase contributions from electronic coupon resources corresponding to item categories having a relatively high return on investment based on item prices or discount amounts, and accordingly to assist in increasing sales in the item categories.

The invention according to claim 11 is the information processing device according to claim 5 in which more of the electronic coupon resources are distributed to a user base having a relatively high return on investment based on item prices or discount amounts, among the user bases.

This invention makes it possible to increase contributions from electronic coupon resources corresponding to user bases having a relatively high return on investment based on itemprices or discount amounts, and accordingly to assist in increasing sales in the user bases.

The invention according to claim 12 is an information processing method performed by a computer. The method includes the following steps. An item for which an electronic coupon is to be issued is identified. The electronic coupon indicates a privilege available in payment for item transactions. A user to which the electronic coupon is to be issued is identified. A plurality of electronic coupon resources available as financial resources for a value corresponding to a privilege of the electronic coupon is identified. The plurality of electronic coupon resources are associated with at least either the item identified as a target for which the electronic coupon is to be issued or the user identified as a target to which the electronic coupon is to be issued. Based on the identified plurality of electronic coupon resources, the allocation of the electronic coupon resources to the value corresponding to the privilege of the electronic coupon is determined. An electronic coupon indicating the privilege corresponding to the total amount of contributions to be contributed from the electronic coupon resources, based on the determined allocation, is issued to the identified user.

The invention according to claim 13 causes a computer to function as target item identifying means, target user identifying means, financial resource identifying means, determining means, and issuing means. The target item identifying means identifies an item for which an electronic coupon is to be issued. The electronic coupon indicates a privilege available in payment for item transactions. The target user identifying means identifies a user to which the electronic coupon is to be issued. The financial resource identifying means identifies a plurality of electronic coupon resources available as financial resources fora value corresponding to a privilege of the electronic coupon. The plurality of electronic coupon resources are associated with at least either the item identified by the target item identifying means or the user identified by the target user identifying means. The determining means determines, based on the plurality of electronic coupon resources identified by the financial resource identifying means, the allocation of the electronic coupon resources to the value corresponding to the privilege of the electronic coupon. The issuing means issues, to the user identified by the target user identifying means, an electronic coupon indicating the privilege corresponding to the total amount of contributions to be contributed from the electronic coupon resources, based on the allocation determined by the determining means.

### Advantageous Effects of Invention

This invention enables the allocation of electronic coupon resources to be quickly and flexibly determined, depending on an item for which and a user to which an electronic coupon is to be issued.

### BRIEF DESCRIPTION OF DRAWINGS

FIG. 1 is a diagram schematically showing an example configuration of an information providing system S according to this embodiment.

FIG. 2A is a block diagram schematically showing an example configuration of an information providing server SA according to this embodiment.

FIG. 2B is a diagram showing example functional blocks in a system controller 4.

FIG. 3 is a schematic diagram illustrating an example where a target user's viewing history is supplemented by using estimated viewing duration information.

FIG. 4 is a schematic diagram illustrating an example where the target user's viewing history is supplemented by using estimated viewing order information.

FIG. 5 is a flowchart showing an example of an estimated viewing duration information generation process performed by the system controller 4.

FIG. 6 is a flowchart showing an example of an estimated viewing order information generation process performed by the system controller 4.

FIG. 7 is a flowchart showing an example of an electronic coupon issue process (Pull-type) performed by the system controller 4.

FIGS. 8A and 8B are each a diagram showing a list of an issue target item's store item code, common item code, store code, and price and comparison target items'store item codes, common item codes, store codes, and prices.

FIG. 9A is a diagram showing a list of an issue target item's store item code, common item code, store code, and price and comparison target items'store item codes, common item codes, store codes, prices, and log flags.

FIG. 9B is a diagram showing a list of an issue target item's store item code, common item code, store code, and price and comparison target items'store item codes, common item codes, store codes, prices, log flags, and estimated log flags.

FIGS. 10A and 10B are each a flowchart showing an example of an estimated viewed item identification process.

FIG. 11A is a diagram showing a list of an issue target item's store item code, common item code, store code, and price and comparison target items'store item codes, common item codes, store code, prices, stock quantities, estimated numbers of demands, and total stock quantities.

FIG. 11B is a diagram showing examples of a coupon amount corresponding to a privilege relative to the difference in price from the cheapest comparison target item.

FIG. 12 is a diagram showing an example of information stored in a financial resource information database 27.

FIG. 13 is a diagram showing a list of store codes, the prices of items, the stock quantities of the items, estimated numbers of demands for the items, total stock quantities, base amounts, and remaining budgets.

FIGS. 14A to 14E are each a diagram illustrating an example where electronic coupon resources having a relatively large remaining budget are preferentially allocated.

FIG. 15A is a diagram illustrating an example where electronic coupon resources whose remaining budget divided by the corresponding number of potential users is relatively large are preferentially allocated.

FIG. 15B is a diagram illustrating an example where electronic coupon resources whose remaining budget divided by the corresponding expected-to-be-sold stock quantity is relatively large are preferentially allocated.

FIG. 16 is a flowchart showing an example of an electronic coupon issue process (Push-type) performed by the system controller 4.

FIG. 17A is a diagram showing a list of issue target items' store item codes, common item codes, store codes, and prices.

FIG. 17B is a diagram showing comparison target items'store item codes, common item codes, store codes, prices, and user IDs identified for each comparison target item.

FIG. 18A is a diagram showing a list of coupon amounts, each of which is determined for each target user and each issue target item.

FIG. 18B is a diagram showing a list of electronic coupon resources, each of which is identified for each target user.

### DESCRIPTION OF EMBODIMENTS

The following describes an embodiment of the present invention with reference to the drawings. In the embodiment described below, the present invention is applied to an information providing system.

### 1. Configuration and Functional Overview of Information Providing System

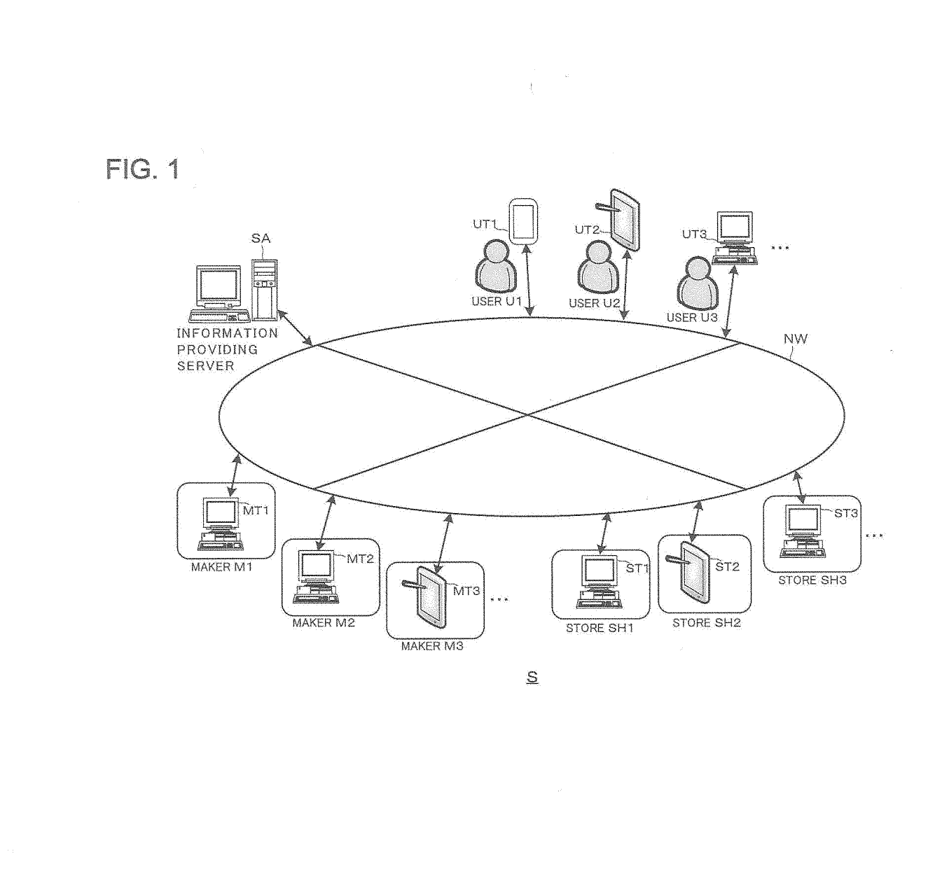

A configuration and a functional overview of an information providing system S according to this embodiment is first described with reference to FIG. 1 and other figures. FIG. 1 is a diagram schematically showing an example configuration of the information providing system S according to this embodiment. As shown in FIG. 1, the information providing system S includes, for example, a plurality of maker terminals MTl (l=1, 2, 3 ... ), a plurality of store terminal STm (m=1, 2, 3 ... ), a plurality of user terminal UTn (n=1, 2, 3 ... ), and an information providing server SA. The maker terminals MTl, the store terminals STm, the user terminals UTn, and the information providing server SA are each connected to a network NW. The network NW includes, for example, the Internet, a dedicated communication line (e.g., community antenna television (CATV) line), a mobile communication network (including base stations), and a gateway.

Each maker terminal MTl is a terminal device used by a maker Ml (l=1, 2, 3 ... ) that manufactures items. Each store terminal STm is a terminal device used by a store SHm (m=1, 2, 3 ... ) that sells items. A maker and a store are each an example of a providing entity that provides items. Each user terminal UTn is a terminal device used by a user Un (n=1, 2, 3 ... ) who wishes to purchase items. The maker terminals MTl, the store terminals STm, and the user terminals UTn each include, for example, an input/display unit, a communication unit, a storage unit, and a controller. The input/display unit includes a touch screen having an input function and a display function. The input function receives operations (user operations) performed with someone's finger, a pen, or the like.

The display function displays information on a display screen. The communication unit is responsible for connecting to the network NW and for controlling the state of communications. The storage unit stores an operating system (OS), application programs, a web browser program, and other programs. The controller includes, for example, a central processing unit (CPU), a read only memory (ROM), and a random access memory (RAM). The controller executes the application programs, the web browser program, and other programs on the OS. For example, a personal computer (PC), a mobile phone, a personal digital assistant (PDA), a mobile terminal (smartphone) that is a mobile phone integrated with a personal digital assistant, or a mobile gaming device can be used as a maker terminal MTl, a store terminal STm, and a terminal UTn. Each of the maker terminals MTl, the store terminals STm, and the user terminals UTn is capable of accessing and communicating with the information providing server SA via its communication unit and the network NW. Each of the maker terminals MTl, the store terminals STm, and the user terminals UTn displays, in a window of its web browser, for example, a web page that is sent from the information providing server SA in response to a request to the information providing server SA.

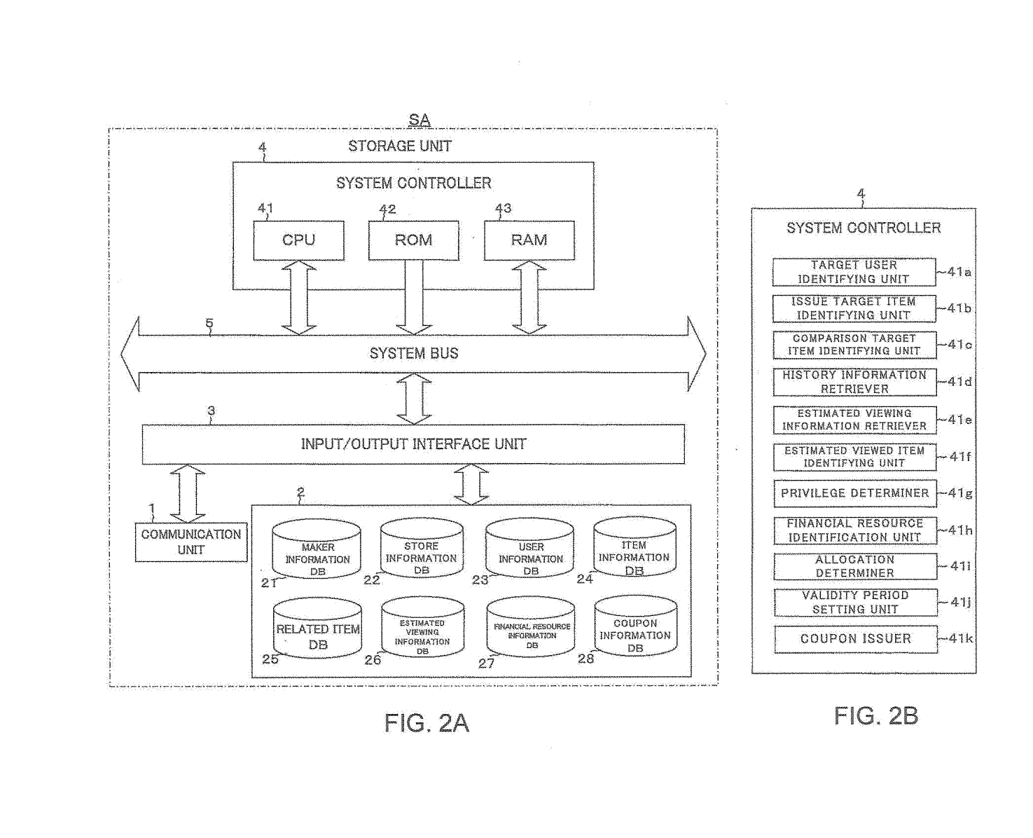

The information providing server SA is an example of an information processing device according to the present invention. The information providing server SA is a server that provides websites, such as a shopping site and an auction site. FIG. 2A is a block diagram schematically showing an example configuration of the information providing server SA according to this embodiment. As shown in FIG. 2A, the information providing server SA includes, for example, a communication unit 1, a storage unit 2 (an example of storage means), an input/output interface unit 3, and a system controller 4. The system controller 4 and the input/output interface unit 3 are connected via a system bus 5. The communication unit 1 is responsible for connecting to the network NW and for controlling the state of communications. The storage unit 2 includes, for example, hard disk drives. The storage unit 2 stores, for example, an operating system (OS) and server programs (including an information processing program according to the present invention). The server programs are downloaded from a predetermined server to the information providing server SA. Alternatively, the server programs may be stored in a (computer-readable) recording medium, such as a CD or a DVD, and be read from the recording medium into the storage unit 2. The storage unit 2 also stores, for example, electronic data that constitutes web pages. The storage unit 2 further has a maker information database (DB) 21, a store information database (DB) 22, a user information database (DB) 23, an item information database (DB) 24, a related item database (DB) 25, an estimated viewing information database (DB) 26, a financial resource information database (DB) 27, a coupon information database (DB) 28, and other databases, which were created therein.

The maker information database 21 is a database that manages information about makers Ml that became members to use the information providing system S. For example, the maker information database 21 stores, for each maker Ml, the maker Ml's maker ID, password, maker code, and maker item information in association with each other. Each maker ID is identification information unique to the corresponding maker Ml. The maker ID and the password are authentication information required for the maker Ml to log in to the system. Each maker code is a code unique to the corresponding maker Ml and used for others, such as the stores SHm and a site operator, to distinguish makers Ml. The maker item information includes, for example, the common item code of an item manufactured by the maker Ml, the stock quantity of the item, an advertising budget for the item, a sales target for the item, and the actual sales (sales amount) of the item. Each common item code is a code unique to the corresponding item (e.g., the model of the item or an item number unique to the model) and common to a plurality of stores SHm (a code used across the stores) (e.g., the same common item code is assigned to items with the same item specifications and the same maker price (regular price). The maker item information is stored, for example, in response to a registration request from the maker terminal MTl that has accessed the information providing server SA. The stock quantity of the item and the actual sales of the item that are included in the maker item information are updated, for example, every time the transaction of the item is closed (i.e., the sales of the item is completed) or at predetermined intervals. When one maker Ml manufactures multiple types of items with different item specifications, maker item information about the multiple types of items is stored in the maker information database 21.

The store information database 22 is a database that manages information about stores SHm that became members to use the information providing system S. For example, the store information database 22 stores, for each store SHm, the store SHm's store ID, password, store code, and store item information in association with each other. Each store ID is identification information unique to the corresponding store SHm. The store ID and the password are authentication information required for the store SHm to log in to the system. Each store code is a code unique to the corresponding store SHm and used for others, such as the makers Ml and the site operator, to distinguish stores SHm. The store item information includes, for example, the store item code of an item to be sold by the store SHm, the common item code of the item, the stock quantity of the item, an advertising budget for the item, a sales target for the item, and the actual sales (sales amount) of the item. Each store item code is, for example, item identification information assigned to items with the same specifications (of the same model) by the corresponding store SHm and is a unique code in the system S. Items that have the same specifications but are sold by different stores SHm are assigned different store item codes. For example, even single-lens reflex cameras (model: C-123) that were manufactured by a maker Ml and have the same specifications are assigned different store item codes if the items are sold by different stores SHm. The items are also separately and variously priced by the stores SHm. The store item information is stored, for example, in response to a registration request from the store terminal STm that has accessed the information providing server SA. The stock quantity of the item and the actual sales of the item that are included in the store item information are updated, for example, every time the transaction of the item is closed (i.e., the sales of the item is completed) or at predetermined intervals. When one store SHm sells (provides) multiple types of items with different item specifications, store item information about the multiple types of items is stored in the store information database 22.

The user information database 23 is a database that manages information about users Un who became members to use the information providing system S. For example, the user information database 23 stores, for each user Un who became a member, the user Un's user ID, password, user rank, gender, age, item categories of interest, email address, search history, viewing history, bookmark history, and purchase history in association with each other. The search history, the viewing history, the bookmark history, and the purchase history are each an example of history information indicating a history of the user Un's actions (operations). Each user Un's history information may be stored in association with the user ID of the user in a history information database that is provided separately from the user information database 23. Each user ID is identification information unique to the corresponding user Un. The user ID and the password are authentication information required for the user Un to log in to the system. The user rank indicates a rank of membership. For example, the user rank can increase in the order of Silver member, Gold member, Platinum member, and Diamond member. The higher the rank becomes, the more advantageous privilege the user Un can enjoy. Such a user rank is designed to increase (be rated higher), for example, based on the user Un's actual purchases of items and actual answers to questionnaires. Item categories are used to categorize items, for example, broadly into home appliances, food, fashion, interiors, and books. The home appliances are further categorized, for example, into televisions, audio equipment, personal computers, and cameras. The cameras are further categorized, for example, into single-lens reflex cameras and compact cameras. The item categories in which the user Un is interested, among such item categories, are registered, for example, in response to a registration request form the user terminal UTn that has accessed the information providing server SA. The item categories in which the user Un is interested are identifiedbased on the user Un's search history, viewing history, bookmark history, and purchase history and are updated at appropriate times. The information providing server SA can classify the plurality of users Un into a plurality of user bases (segments) using at least one of the users Un's genders, ages, and item categories of interest as the users Un's classification criteria. Examples of the user bases (segments) include “women in their twenties” “women in their thirties”, “men in their twenties” “men in their thirties”, “men who love cameras”, “men who love audio equipment”, “women who love accessories”, and “women who love perfumes”.

The search history includes, for example, search times, search queries, session IDs, and sets of search results in association with each other. Each search time is, for example, the time at which the information providing server SA received a search query or the time at which the information providing server SA performed a search.

A search time maybe expressed as a search date and time, as a search month, date, and time, or as a search year, month, date, and time. The same applies to a viewing time, a bookmark time, a purchase time, and an electronic coupon issue time, which will be described later. Each search query includes one or more words (narrowing criteria). One or more words (narrowing criteria) and numerical values, which the information providing server SA obtain as a search query, are entered, for example, in a word entry field on a web page displayed by the web browser of the user terminal UTn or are specified (clicked or tapped) from a list of item categories. Each set of search results includes, for example, the common item codes of items, which were found by a search based on the corresponding search query (i.e., items that satisfy the search query (e.g., “single-lens reflex” AND “camera”)), the store item codes of the items, the maker codes of manufacturers that manufacture the items, the store codes of stores that sell the items, and item categories to which the items belong. If no items were found by the search based on the search query, the corresponding search results include information (NULL) indicating no hits. The search history includes, for example, records each of which is distinguished from the others by the corresponding search request including a search query from the user terminal UTn. One of the records corresponds to one search. The same search queries maybe included in different records (e.g., when the user Un used the same search query to perform searches on different dates). The same search queries are counted together as one search query. Not only the same search queries but also similar or related search queries may be counted together as one search query. For example, the search query “single-lens reflex & camera” (“&” is usually specified as “ ” (space)), the search query “digital single-lens reflex camera” and the search query “digital camera & reflex” are processed as similar or related search queries. Consequently, these search queries are counted as one search query, even when they are divided into four records. The scope of similar or related search queries is freely determined by the site operator, for example, based on item categories.

The information providing server SA identifies, for example, a search duration for which and a search frequency with which the user Un searched for items, based on his or her search history. The search duration is, for example, the time between the search time included in the first record and the search time included in the last record, among a plurality of records in a session (i.e., a plurality of continuous records including the same session ID). The search frequency is the above number of searches performed within a predetermined period of time (e.g., for the past one week). The information providing server SA identifies, for example, which categories of items the user Un attaches importance to (hereinafter, referred to as “the user Un's important categories”), based on his or her search history. The user Un's important categories are identified, for example, from words or numerical values included in his or her search queries. For example, if the proportion of numerical values in the user Un's search queries (e.g., the proportion relative to the total number of the user Un's search queries) is relatively high, the user's important category is “item price”.

Alternatively, for example, if the proportion of words indicating item specifications in the search queries is relatively high, the user's important category is “item specifications”. The information providing server SA can classify the plurality of users Un into a plurality of user bases (segments) using the users Un's search durations or important categories as the users Un's classification criteria. This can classify the plurality of users Un by type or by tendency. Examples of the user bases (segments) in this case include “short search duration (e.g., less than one minute) ”, “normal search duration (e.g., between one minute and ten minutes), “long search duration (e.g., more than ten minutes)”, “price-oriented”, and “specifications-oriented”.

The viewing history includes, for example, viewing times, viewing durations (lengths), the common item codes of viewed items, the store item codes of the items, the maker codes of manufacturers that manufacture the items, the store codes of stores that sell the items, item categories to which the items belong, viewed area information, session start times, and session end times. Each viewing time is, for example, the time (the display start time or a few seconds after the display start time) at which a web page showing detailed information about the corresponding item was displayed on a window of the web browser of the user terminal UTn. For example, when the user Un performs a viewing operation to select his or her desired item on a web page showing search results (i.e., an item list) based on a search query of the user Un, a web page showing detailed information about the item is obtained from the information providing server SA and displayed on a window of the web browser. Each viewing duration is, for example, the time between the session start time and the session end time in the record of the corresponding viewed item. The viewed area information is sent from the web browser of the user terminal UTn to the information providing server SA at an appropriate time, for example, while a web page is being displayed. The viewed area information may be indicated by coordinates on a web page, or may be indicated by an image or a text. For example, when an image arranged on a web page remains displayed for a predetermined period of time or more, viewed area information indicating the image is included in the viewing history. The viewing history includes, for example, records each of which is distinguished from the others by the corresponding viewing request from the user terminal UTn. One of the records corresponds to one view. The information providing server SA can classify the plurality of users Un into a plurality of user bases (segments) using the users Un's viewing durations or viewed area information as the users Un's classification criteria. This can also classify the plurality of users Un by type or by tendency. Examples of the user bases (segments) in this case include “short viewing duration (e.g., less than three minutes)”, “normal viewing duration (e.g., between three and fifteen minutes), “long viewing duration (e.g., more than fifteen minutes)”, “image-oriented”, and “text-oriented”.

The bookmark history includes, for example, bookmark times, the common item codes of bookmarked items (e.g., items bookmarked in accordance with the user Un's bookmark operations), the store item codes of the items, the maker codes of manufacturers that manufacture the items, the store codes of stores that sell the items, and item categories to which the items belong. The purchase history includes, for example, purchase times, purchase prices, the common item codes of purchased items, the store item codes of the items, the maker codes of manufacturers that manufacture the items, the store codes of stores that sell the items, and item categories to which the items belong. The purchase history includes, for example, records each of which is distinguished from the others by the corresponding purchase request from the user terminal UTn. One of the records corresponds to one purchase.

The item information database 24 is a database that manages information about items marketed as transaction obj ects by the stores SHm. For example, the item information database 24 stores, for each of the items marketed as transaction objects by the stores SHm, the common item code of the item, the store item code of the item, the maker code of the manufacturer that manufactures the item, the store code of a store that sells the item, the name of the item, the price of the item, the specifications of the item, an item category to which the item belongs, the stock quantity of the item (the stock quantity of the item in the store SHm that markets the item), and a coupon issue flag in association with each other. The coupon issue flag indicates whether to issue an electronic coupon for the item. For example, the coupon issue flag is used in an electronic coupon issue process (Push-type) to be described later. The item information database 24 may store, separately for each store SHm or each maker

Ml, how many times an item was searched for, how many times the item was viewed, how many times the item was bookmarked, and how many times the item was purchased, in association with a store item code. For example, the related item database 25 stores, for each group including mutually related items, the common item codes of the mutually related items in association with each other. The scope of related items is freely determined by the site operator, for example, based on item categories.

The estimated viewing information database 26 is a database that manages at least either estimated viewing information indicating each item's estimated viewing duration identified based on the history information of each of the plurality of users Un (hereinafter, referred to as “estimated viewing duration information”) or estimated viewing information indicating each item's estimated viewing rank identified based on the history information of each of the plurality of users Un (hereinafter, referred to as “estimated viewing order information”). Estimated viewing duration information and estimated viewing order information are each generated for each of a plurality of separate search queries and then stored in association with each search query. Each search query may be one search query, such as “single-lens reflex & camera”. Alternatively, each search querymay be a search query group including similar or related search queries as described above. For example, each piece of estimated viewing duration information includes, for each item (each store item code, in this embodiment), the item's store item code and estimated viewing duration in association with each other. The estimated viewing duration is, for example, the average value (or standard deviation value) of elapsed times, each of which is the time between a search time and a corresponding viewing time (in other words, the time required between a search and a subsequent viewing) of each of the plurality of users Un. On the other hand, each piece of estimated viewing order information includes, for each item (each store item code, in this embodiment), the item's store item code and estimated viewing rank in association with each other. The estimated viewing rank is, for example, a rank relative to the average value (or standard deviation value) of elapsed times, each of which is the time between a search time and a corresponding viewing time of each of the plurality of users Un. The shorter the average value (or standard deviation value) of the elapsed times, the upper rank (higher) the rank becomes. This estimated viewing information database 26 enables even an item that is not included in the history information of a user Un to be provided with information (e.g., to which an electronic coupon is to be issued) to be identified and used as if the item had been viewed by the user Un.

The financial resource information database 27 is a database that manages information about financial resources (in other words, budgets) for electronic coupons each indicating a privilege available in payment for item transactions. Hereinafter, financial resources for electronic coupons are referred to as “electronic coupon resources”. Examples of a privilege available in payment for item transactions include a predetermined amount (e.g., 1,000 yen) reduction in price (discount) from an item price and a predetermined percentage (e.g., 50%) discount off an item price. For example, when the privilege of an electronic coupon is “¥1,000 discount” off an item price, the price corresponding to the privilege (i.e., the value of the electronic coupon, which is also referred to as the price reduction (discount amount)) is ¥1,000. When the privilege of an electronic coupon is 50% discount off the item price ¥1,000, the price corresponding to the privilege (i.e., the value of the electronic coupon, which is also referred to as the price reduction (discount amount)) is ¥1,000. In this embodiment, the allocation of electronic coupon resources to a value (hereinafter, referred to as a “coupon amount”) corresponding to a privilege, which is determined in a manner that will be described later, is determined. Based on the determined allocation, an electronic coupon indicating a coupon amount corresponding to the total amount of contributions to be contributed from the electronic coupon resources is issued.

For example, the financial resource information database 27 stores, for each electronic coupon resource, a financial resource type, a financial resource provider (providing entity), a total budget, a base amount, an additional amount, a cumulative contribution, a remaining budget, a target use deadline, a to-be-funded item, and a to-be-funded user in association with each other. Examples of the financial resource type include store financial resources, maker financial resources, and event financial resources. The store financial resources are, for example, electronic coupon resources for which a predetermined number of stores SHm secure and prepare budgets. The maker financial resources are, for example, electronic coupon resources for which a predetermined number of makers Ml secure and prepare budgets. The event (e.g., campaign) financial resource is, for example, electronic coupon resources for which the site operator and advertisers secure and prepare budgets. When the financial resource type indicates store financial resources, the financial resource provider is, for example, a store SHm that provides the electronic coupon resource and is indicated by its store code. When the financial resource type indicates maker financial resources, the financial resource provider is, for example, a maker Ml that provides the electronic coupon resource and is indicated by its maker code. When the financial resource type indicates event financial resources, the financial resource provider is, for example, the site operator or an advertiser that provides the electronic coupon resource and is indicated by the name of the site operator or the advertiser, an event name, or the like. The total budget is an electronic coupon resource initially prepared by the financial resource provider. The base amount is an upper limit for a contribution that is contributed to one electronic coupon. The additional amount is an upper limit for a contribution amount that is additionally contributed under a predetermined condition when the base amount, which was contributed based on an allocation, is still less than the coupon amount of an electronic coupon. The cumulative contribution is the cumulative amount of contributions already contributed. The remaining budget is the remainder obtained by subtracting the cumulative contribution from the total budget (i.e., the electronic coupon resource that remains after contribution of a predetermined amount). That is, the electronic coupon resource corresponds to the initial amount (i.e., the total budget) and the balance after use of contribution(s) (i.e., the remaining budget). The target use deadline is a target deadline for using the electronic coupon resource and is set by the financial resource provider.

The to-be-funded item indicates items to be funded with the electronic coupon resource. For example, the to-be-funded item of an electronic coupon resource provided by the store SH1 indicates items to be funded with the electronic coupon resource, that is, all or some items that the store SH1 sells by their common item codes. For example, the to-be-funded item of an electronic coupon resource provided by the maker Ml indicates items to be funded with the electronic coupon resource, that is, all or some items that the maker Ml manufactures by their common item codes. For example, the to-be-funded item of an electronic coupon resource provided by the site operator indicates all items (no items are particularly limited).

The to-be-funded user indicates users to be funded with the electronic coupon resource. For example, the to-be-funded user of an electronic coupon resource provided by the store SH1 and the to-be-funded users of an electronic coupon resource provided by the maker Ml each indicate all users (no users are particularly limited). For example, the to-be-funded user of an electronic coupon resource provided by the site operator indicates users to be funded with the electronic coupon resource by a user rank (e.g., Diamond member). In this case, users who meet the user rank (e.g., who are Diamond members) is to be funded with the electronic coupon resource. In some cases, an electronic coupon resource is provided for each user rank. In such cases, the to-be-funded user of each electronic coupon resource indicates the corresponding user rank (e.g., (i) Silver member, (ii) Gold member, (iii) Platinum member, and (iv) Diamond member). The total budgets of these electronic coupon resources may be the same or different.

In some cases, the to-be-funded user of an electronic coupon resource indicates users to be funded with the electronic coupon resource by a range in the price of items purchased during a predetermined period of time (e.g., the price of purchases within the past month is ¥50,000 or more). In such cases, users who meet a range in the total price of items purchased during the predetermined period of time (e.g., whose price of purchases within the past month is ¥50,000 or more) is to be funded with the electronic coupon resource. For example, for an electronic coupon resource provided by the store SHl, the total price of purchases is calculated on the basis of items sold by the store SH1. For example, for an electronic coupon resource provided by the maker Ml, the total price of purchases is calculated on the basis of items manufactured by the maker Ml. For example, for an electronic coupon resource provided by the site operator, the total price of purchases is calculated on the basis of all items stored in the item information database 24. In some cases, an electronic coupon resource is provided for each range in the total price of purchased items. In such cases, the to-be-funded user of each electronic coupon resource indicates the corresponding range in the total price of purchases (e.g., (i) less than ¥10,000, (ii) ¥10,000 or more and less than ¥50,000, (iii) ¥50,000 or more and less than ¥100, 000, and (iv) ¥100, 000 or more). The total budgets of these electronic coupon resources maybe the same or different.

In some cases, the to-be-funded user of an electronic coupon resource indicates users to be funded with the electronic coupon resource by a range in the number of purchases of items during a predetermined period of time (e.g., the number of purchases within the past month is ten or more times). In such cases, users who meet a range in the number of purchases during the predetermined period of time (e.g., whose number of purchases within the past month is ten or more times) is to be funded with the electronic coupon resource. For example, for an electronic coupon resource provided by the store SHl, the number of purchases is calculated on the basis of items sold by the store SH1. For example, for an electronic coupon resource provided by the maker Ml, the number of purchases is calculated on the basis of items manufactured by the maker Ml. For example, for an electronic coupon resource provided by the site operator, the number of purchases is calculated on the basis of all items stored in the item information database 24. In some cases, an electronic coupon resource is provided for each range in the number of purchases of items. In such cases, the to-be-funded user of each electronic coupon resource indicates the corresponding range in the number of purchases (e.g., (i) zero times, (ii) once or more and less than five times, (iii) five or more times and less than ten times, and (iv) ten or more times). The total budgets of these electronic coupon resources may be the same or different.

The total budget of an electronic coupon resource may be distributed among item categories in a predetermined distribution ratio. The distribution ratio of the electronic coupon resources is set to an equal ratio among the item categories. For example, when items that the store SH1 sells range over four item categories (e.g., televisions, audio equipment, personal computers, and cameras), the distribution ratio of electronic coupon resources provided by the store SH1 is set to 25% for each of the item categories. Alternatively, the distribution ratio of the electronic coupon resources is set higher for an item category including a relatively large number of items. The number of items is, for example, the number of items that the store SH1 sells or the number of items that the maker Ml manufactures. Alternatively, the distribution ratio of the electronic coupon resources is set higher for an item category including a relatively large stock quantity. The stock quantity is, for example, the number of items that the store SH1 keeps in stock or the number of items that the maker Ml keeps in stock.

The distribution ratio of the electronic coupon resources is effective when set higher for an item category having a relatively high purchase expectation (an example of the expectation that item transactions are expected to be closed). That is, if more electronic coupon resources are distributed to an item category having a relatively high purchase expectation, electronic coupon resources distributed among item categories can increase contributions from electronic coupon resources corresponding to item categories having a relatively high purchase expectation, and accordingly can assist in closing transactions of items that belong to the item categories. Item categories having a high purchase expectation correspond to item categories to which the following items belong. At least one of the number of times that each of the items was searched for, the number of times that the item was viewed, the number of times that the item was bookmarked, and the number of times that the item was purchased is relatively large. For example, the system controller 4 calculates, for each item that the store SH1 sells, at least one of the number of times that the item was searched for, the number of times that the item was viewed, the number of times that the item was bookmarked, and the number of times that the item was purchased. The system controller 4 then totals, for each item category (that the store SH1 deals with), the calculated numbers to calculate a purchase expectation. The number of times that an item was searched for, the number of times that the item was viewed, the number of times that the item was bookmarked, and the number of times that the item was purchased can be calculated from information stored in the item information database 24 and various histories stored in the user information database 23. For example, when items that the store SH1 sells range over four item categories (e.g., televisions, audio equipment, personal computers, cameras), the distribution ratio of electronic coupon resources provided by the store SH1 is set to 40% for the item category “cameras” having the highest purchase expectation, 30% for the item category “audio equipment” having the second highest purchase expectation, 20% for the item category “personal computers” having the third highest purchase expectation, and 10% for the item category “televisions” having the lowest purchase expectation.

The distribution ratio of the electronic coupon resources is effective when set higher for an item category in which electronic coupons issued in the past are used at a relatively high rate. That is, if more electronic coupon resources are distributed to an item category in which electronic coupons issued in the past are used at a relatively high rate, electronic coupon resources distributed among item categories can increase contributions from electronic coupon resources corresponding to item categories in which electronic coupons issued in the past are used at a relatively high, and accordingly can assist in closing transactions of items that belong to the item categories. For example, the system controller 4 totals, for each item category (that the store SH1 deals with), the number of items for which electronic coupons were issued, among items that the store SH1 sells, and then calculates, for each item category, the percentage of items for which electronic coupons were used in payment among them, to calculate at what rate electronic coupons were used. The distribution ratio of the electronic coupon resources is effective when set higher for an item category having a relatively high return on investment (ROI). That is, if more electronic coupon resources are distributed to item categories having a relatively high return on investment, electronic coupon resources distributed among item categories can increase contributions from electronic coupon resources corresponding to item categories having a relatively high return on investment, and accordingly can assist in increasing sales in the item categories. The return on investment is, for example, expressed numerically and determined based on item prices or coupon amounts. For example, the system controller 4 totals, for each item category, the prices of items that the store SH1 sells or the coupon amounts of electronic coupons issued for the items, to calculate a return on investment.

The total budget of an electronic coupon resource may be distributed among user bases (segments) in a predetermined distribution ratio. The distribution ratio of the electronic coupon resources is set to an equal ratio among the user bases. For example, when the user bases are “women in their twenties”, “women in their thirties”, “women in their forties”, and “women in their fifties”, the distribution ratio of the electronic coupon resources is set to 25% for each of the user bases. Alternatively, the distribution ratio of the electronic coupon resources is set higher for a user base including a relatively large number of users. The number of users included in each user base can be calculated from information stored in the user information database 23.

The distribution ratio of the electronic coupon resources is effective when set higher for a user base having a relatively high purchase expectation. That is, if more electronic coupon resources are distributed to a user base having a relatively high purchase expectation, electronic coupon resources distributed among user bases can increase contributions from electronic coupon resources corresponding to user bases having a relatively high purchase expectation, and accordingly can assist in closing transactions by users who belong to the user bases. User bases having a high purchase expectation correspond to user bases to which the following users belong. At least one of the number of searches, the number of views, the number of bookmarks, and the number of purchases by each of the users is relatively large. For example, the system controller 4 calculates, for each of the users, at least one of the number of searches, the number of views, the number of bookmarks, and the number of purchases (the number of purchases is the number of items that the user purchased, but may be the number of purchased added up for each purchase request. The system controller 4 then totals, for each user base, the calculated numbers to calculate a purchase expectation. The number of searches, the number of views, the number of bookmarks, and the number of purchases by a user can be calculated from various histories stored in the user information database 23. For example, when the user bases are “women in their twenties”, “women in their thirties”, “women in their forties”, and “women in their fifties”, the distribution ratio of electronic coupon resources is set to 40% for the user base “women in their thirties” having the highest purchase expectation, 30% for the user base “women in their twenties” having the second highest purchase expectation, 20% for the user base “women in their forties” having the third highest purchase expectation, and 10% for the user base “women in their fifties” having the lowest purchase expectation.

The distribution ratio of the electronic coupon resources is effective when set higher for a user base that uses electronic coupons issued in the past at a relatively high rate. That is, if more electronic coupon resources are distributed to a user base that uses electronic coupons issued in the past at a relatively high rate, electronic coupon resources distributed among user bases can increase contributions from electronic coupon resources corresponding to user bases that use electronic coupons issued in the past at a relatively high, and accordingly can assist in closing transactions by users who belong to the user bases. For example, the system controller 4 totals, for each user base, the number of users to which electronic coupons were issued, and then calculates, for each user base, the percentage of users who used electronic coupons in payment, to calculate at what rate the user bases uses electronic coupons. The distribution ratio of the electronic coupon resources is effective when set higher for a user base having a relatively high return on investment (ROI). That is, if more electronic coupon resources are distributed to a user base having a relatively high return on investment, electronic coupon resources distributed among user bases can increase contributions from electronic coupon resources corresponding to user bases having a relatively high return on investment, and accordingly can assist in increasing sales in the user bases. For example, the system controller 4 totals, for each user base, the prices of items that users in the user base purchased or the coupon amounts of electronic coupons that the user used, to calculate a return on investment.

The coupon information database 28 is a database that manages management information of issued electronic coupons. The coupon information database 28 stores, for each of the issued electronic coupons, management information, such as coupon ID of the electronic coupon, the common item code of an item for which the electronic coupon was issued, the store item code of the item, the maker code of a manufacturer that manufactures the item, the store code of a store that sells the item, the user ID of a user to which the electronic coupon was issued, the issue time of the electronic coupon, the privilege (coupon amount) of the electronic coupon, the contributor and the contribution of electronic coupon resources, a validity period for the electronic coupon, and whether the electronic coupon was used, in association with each other. Each user ID is identification information unique to the corresponding issued electronic coupon.

The system controller 4 as a computer includes, for example, a CPU 41 (processor), a ROM 42, and a RAM 43 (an example of storage means). The system controller 4 executes, for example, the server programs on the OS. FIG. 2B is a diagram showing example functional blocks in the system controller 4. As shown in FIG. 2B, the system controller 4 (the processor in the system controller 4) executes the server programs to function as, for example, a target user identifying unit 41a, an issue target item identifying unit 41b, a comparison target item identifying unit 41c, a history information retriever 41d, an estimated viewing information retriever 41e, an estimated viewed item identifying unit 41f, a privilege determiner 41g, a financial resource identification unit 41h, an allocation determiner 41i, a validity period setting unit 41j, and a coupon issuer 41k. The target user identifying unit 41a is an example of target user identifying means. The issue target item identifying unit 41b is an example of target item identifying means. The financial resource identification unit 41h is an example of financial resource identifying means. The allocation determiner 41i is an example of determining means, user counting means, item counting means, and calculating means. The coupon issuer 41k is an example of issuing means.

The target user identifying unit 41a identifies a user Un (e.g., identifies the user ID of the user) to which an electronic coupon is to be issued (hereinafter, referred to as a “target user”), for example, from among the users Un that were registered (i.e., whose user IDs are stored) in the user information database 23.

The issue target item identifying unit 41b identifies one or more items (e.g., identifies the common item code(s) and the store item code (s) of the item (s)) for which the electronic coupon is to be issued (hereinafter, referred to as “issue target item (s) ”), for example, from among the items that were registered (i.e., whose item IDs are stored) in the item information database 24.

The comparison target item identifying unit 41c identifies one or more items (e.g., identifies the common item code (s) and the store item code (s) of the item (s)) that are to be compared with the issue target item(s) identified by the issue target item identifying unit 41b (hereinafter, referred to as “comparison target item(s)”), for example, from among the items registered in the item information database 24. When a plurality of issue target items are identified, a comparison target item is identified for each issue target item. The comparison target item identifying unit 41c identifies, for example, an item whose common item code is the same as that of an issue target item and whose store item code is different from that of the issue target item as a comparison target item. This item is an item that another store SHm than a store that sells the issue target item sells. The comparison target item identifying unit 41c may also identify an item whose common item code is related to that of an issue target item and whose store item code is different from that of the issue target item as a comparison target item. This item is also an item that another store SHm than a store that sells the issue target item sells. An item whose common item code is the same as or related to that of an issue target item can be regarded as a competing item that competes with the issue target item in sales. An item whose common item code is related to that of an issue target item can be identified from the related item database 25.

The comparison target item identifying unit 41c may identify an item whose common item code is the same as or related to that of an issue target item, whose store item code is different from that of the issue target item, and that is identified from the above target user's history information as a comparison target item. The history information retriever 41d retrieves the target user's history information (i.e., the history information associated with the user ID of the target user) from the user information database 23. The history information retriever 41d then identifies which items were searched for, viewed, or bookmarked by the target user, for example, from the search history, the viewing history, or the bookmark history included in the retrieved history information. From among items whose common item code is the same as or related to that of the issue target item, the comparison target item identifying unit 41c identifies an item identified from the history information as a comparison target item. Such an item is likely to be an item that the target user is concerned with (or interested in). Thus, identifying such an item as a comparison target item allows the privilege determiner 41g to determine a more appropriate privilege. From among items whose common item code is the same as or related to that of the issue target item and that are identified from the above target user's history information, the comparison target item identifying unit 41c may identify an item whose number of searches or number of views, which is identified from the history information (i.e., the search history or the viewing history), is greater than or equal to a predetermined number of times (threshold value) as a comparison target item. This is because the target user is more concerned with (or interested in) an item searched for or viewedmore frequently. Thus, identifying such an item as a comparison target item can determine a much more appropriate privilege.

The comparison target item identifying unit 41c is more effective when comparing the search time (or the viewing time) of the issue target item with the search time (or the viewing time) of each of the items whose common item code is the same as or related to that of the issue target item, and then identifying an item (i.e., whose common item code is the same as or related to that of the issue target item) whose difference between the times (the search times or the viewing times) is less than (or less than or equal to) a predetermined difference (threshold value: e.g., about thirty minutes) as a comparison target item. It is likely that such an item was searched for or viewed around the same time as the issue target item. Thus, identifying such an item as a comparison target item can determine a much more appropriate privilege. The search time and viewing time of the issue target item and the search time and viewing time of an item whose common item code is the same as or related to that of the issue target item are each identified from the target user's history information retrieved by the history information retriever 41d.

As described above, use of the target user's history information can identify a more appropriate comparison target item. However, it can be difficult to retrieve all the history information of the target user. For example, there may be a case where between when a comparison target item is identified based on the target user's history information and, following this as will be described later, an electronic coupon issued by the coupon issuer 41k is provided to the target user and when the target user actually sees the provided electronic coupon, the target user views another item. This is because there is a time lag between the time when the electronic coupon is issued (generated) based on the target user's history information and the time when the target user views the provided electronic coupon. In this case, a history of viewing the above other item is not reflected in the identification of the comparison target item based on the target user's history information. Thus, it will be difficult to identify a more appropriate comparison target even if using the target user's history information. Also for example, when the target user uses different types of user terminals STm (e.g., personal computers (desktops) and mobile terminals), different types of web browser programs, or different types of websites, it is difficult to integrate pieces of history information about those into one piece. Even when the target user uses the same website, it is difficult to retrieve all the history information of the target user if using the website in a non-logged in state. In such a case, it will be difficult to identify a more appropriate comparison target even if using the target user's history information.

For this reason, in this embodiment, by using the estimated viewing duration information or the estimated viewing order information stored in the estimated viewing information database 26, an item not included in the target user's history information is identified as an item that would have been viewed by the target user, and the identified item is added to the target user's viewing history.

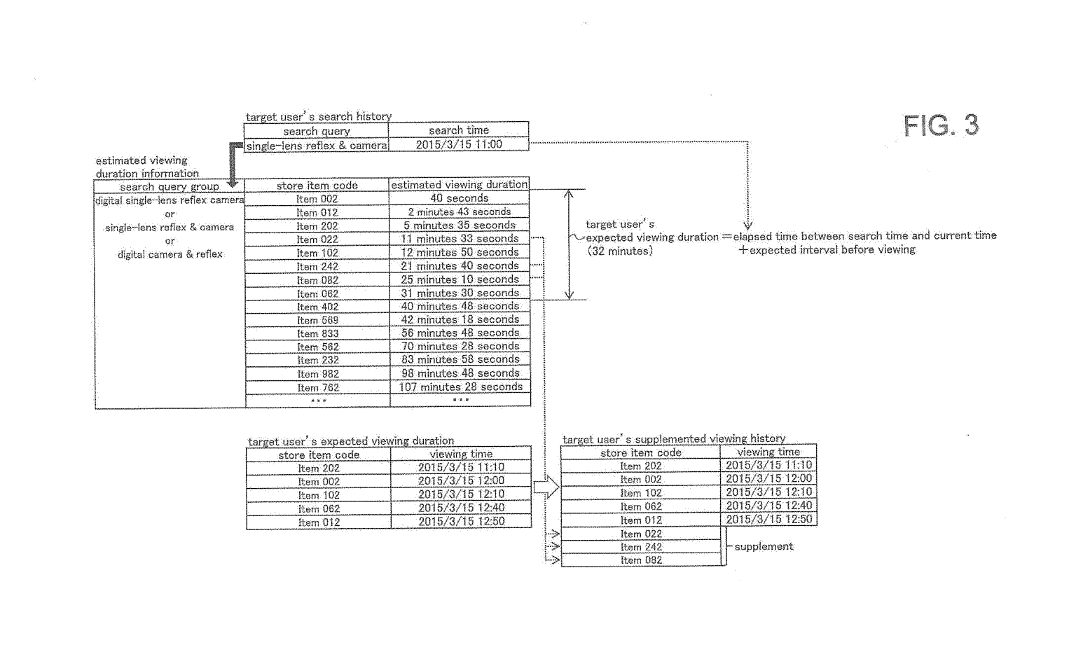

How to add items identified by using the estimated viewing duration information to the target user's viewing history will now be described with reference to FIG. 3. FIG. 3 is a schematic diagram illustrating an example where the target user's viewing history is supplemented by using the estimated viewing duration information. In this case, the estimated viewing information retriever 41e identifies, from the search history included in the target user's history information, a search query of the target user and the search time associated with the search query. Subsequently, the estimated viewing information retriever 41e retrieves the estimated viewing duration information corresponding to the search query identified from the target user's search history from the estimated viewing information database 26. For example, the estimated viewing information retriever 41e retrieves the estimated viewing duration information associated with a search query identical to the search query identified from the target user's search history. Alternatively, the estimated viewing information retriever 41e retrieves the estimated viewing duration information associated with a search query group including the search query identified from the target user's search history. In the example of FIG. 3, the estimated viewing duration information associated with a search query group including the search query “single-lens reflex & camera” identified from the target user's search history is retrieved.

Subsequently, the estimated viewed item identifying unit 41f adds the elapsed time between the search time identified from the target user's search history and the current time (i.e., the time when this process is performed) to an expected interval between the current time and the target user's viewing, to calculate an expected viewing duration (32 minutes, in the example of FIG. 3). The estimated viewed item identifying unit 41f then identifies items associated with an estimated viewing duration that is less than (or less than or equal to) the above calculated expected viewing duration (i.e., the expected viewing duration > or ≧ the estimated viewing duration), among the items included in the estimated viewing duration information retrieved by the estimated viewing information retriever 41e. Among the items thus identified (the items whose store item codes are Item002 to Item062, in the example of FIG. 3), items (the items whose store item codes are Item022, Item242, and Item082, in the example of FIG. 3) not included in the target user's history information (i.e., viewing history) are referred to as estimated viewed items (supplementary items). The estimated viewed item identifying unit 41f adds the above identified estimated viewed items to the target user's viewing history, to generate a supplemented viewing history as illustrated in FIG. 3.

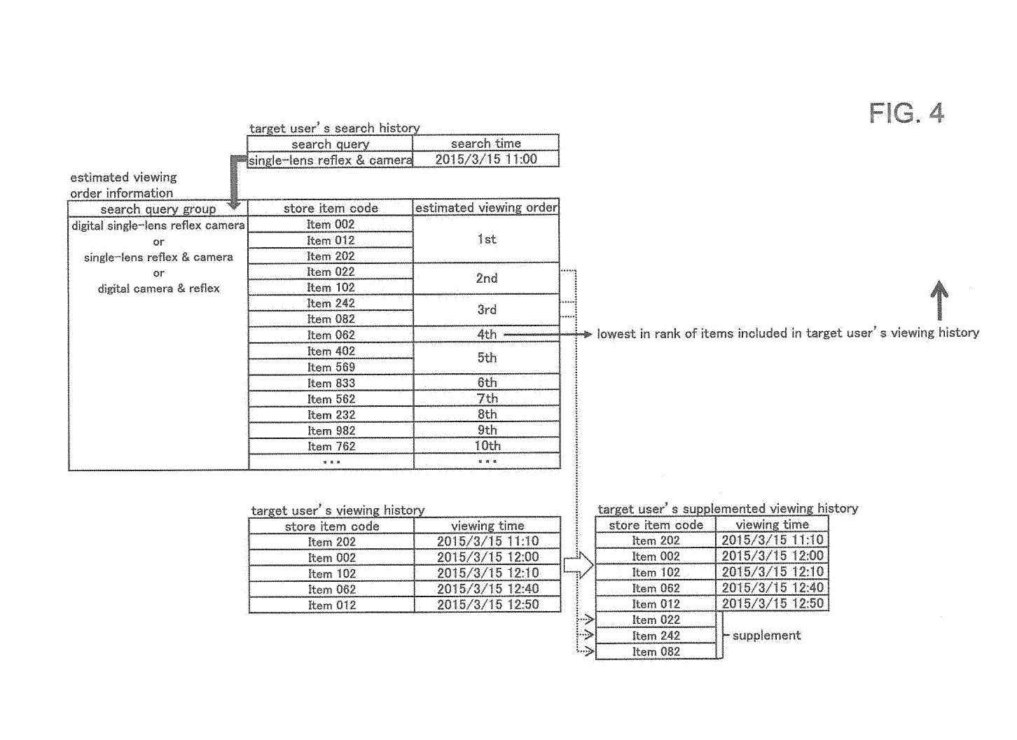

With reference to FIG. 4, the following describes how to add items identified by using the estimated viewing order information to the target user's viewing history. FIG. 4 is a schematic diagram illustrating an example where the target user's viewing history is supplemented by using the estimated viewing order information. In this case, the estimated viewing information retriever 41e identifies a search query of the target user from the search history included in the target user's history information. Subsequently, the estimated viewing information retriever 41e retrieves the estimated viewing order information corresponding to the search query identified from the target user's search history from the estimated viewing information database 26. For example, the estimated viewing information retriever 41e retrieves the estimated viewing order information associated with a search query identical to the search query identified from the target user's search history. Alternatively, the estimated viewing information retriever 41e retrieves the estimated viewing order information associated with a search query group including the search query identified from the target user's search history. In the example of FIG. 4, the estimated viewing order information associated with a search query group including the search query “single-lens reflex & camera” identified from the target user's search history is retrieved. Alternatively, the estimated viewing information retriever 41e may retrieve estimated viewing order information including a plurality of item combinations included in the target user's history information (i.e., viewing history) In the example of FIG. 4, the items (the items whose store item codes are Item202 to Item012) included in the target user's viewing history are all included in the estimated viewing order information. Thus, even if no search query is identified from the target user's search history, the estimated viewing order information can be retrieved. The estimated viewed item identifying unit 41f then identifies, from the estimated viewing order information, items that rank higher than an item of the lowest estimated viewing rank (the item whose store item code is Item062, in the example of FIG. 4), among items that are included both in the target user's viewing history and in the estimated viewing order information retrieved by the estimated viewing information retriever 41e. Among the items thus identified (the items whose store item codes are Item002 to Item082, in the example of FIG. 4), items (the items whose store item codes are Item022, Item242, and Item082, in the example of FIG. 4) not included in the target user's history information (i.e., viewing history) are referred to as estimated viewed items. The estimated viewed item identifying unit 41f adds the above identified estimated viewed items to the target user's viewing history, to generate a supplemented viewing history as illustrated in FIG. 4.

The comparison target item identifying unit 41c identifies an estimated viewed item whose common item code is the same as or related to that of an issue target item, whose store item code is different from that of the issue target item, and that is identified by the estimated viewed item identifying unit 41f as a comparison target item. Thus, even if there is a time lag between the time when an electronic coupon is issued based on the target user's history information and the time when the target user views the provided electronic coupon and even if it can be difficult to retrieve all the history information of the target user, a more appropriate comparison target item can be identified and a much more appropriate privilege can be determined.

Subsequently, the privilege determiner 41g determines a privilege (e.g., a predetermined amount reduction in price and a predetermined percentage discount off an item price) relative to the difference in price between the issue target item identified by the issue target item identifying unit 41b and the comparison target item identified by the comparison target item identifying unit 41c. For example, when the price of the issue target item is higher than the price of the comparison target item, the difference calculated by subtracting the price of the comparison target item from the price of the issue target item is determined to be a coupon amount corresponding to the privilege. That is, in this case, the difference in price is equal to the coupon amount. Thus, the issue target item can compete with the comparison target item (e.g., a competing item) on price. Alternatively, the privilege determiner 41g may determine the amount calculated by adding a predetermined amount to the difference to be the coupon amount. In this case, for example, when the difference is ¥1,000, the coupon amount is determined to be ¥1,200 (i.e., the coupon amount is increased).

Next, the financial resource identification unit 41h identifies, from the financial resource information database 27, a plurality of electronic coupon resources that are available as financial resources for the coupon amount corresponding to the privilege determined by the privilege determiner 41g and that are associated with at least either the issue target item identified by the issue target item identifying unit 41b or the target user identified by the target user identifying unit 41a. The electronic coupon resources associated with the issue target item correspond to, for example, electronic coupon resources associated with a to-be-funded item indicating the issue target item (e.g., indicating the common item code of the issue target item) in the financial resource information database 27. The electronic coupon resources associated with the target user correspond to, for example, electronic coupon resources associated with a to-be-funded user indicating the target user (e.g., indicating the user rank of the target user) in the financial resource information database 27.

Subsequently, based on the plurality of available electronic coupon resources identified by the financial resource identification unit 41h, the allocation determiner 41i determines the allocation of electronic coupon resources to the coupon amount corresponding to the privilege determined by the privilege determiner 41g. For example, the allocation determiner 41i preferentially allocates electronic coupon resources having a relatively high remaining budget to the coupon amount.

Next, the validity period setting unit 41j sets a validity period for an electronic coupon indicating the privilege determined by the allocation determiner 41i. For example, the validity period for the electronic coupon is set to a predetermined period (e.g., a few hours).

Subsequently, the coupon issuer 41k issues, to the target user identified by the target user identifying unit 41a, an electronic coupon indicating the privilege corresponding to the total amount of contributions that are contributed from the electronic coupon resources based on the allocation determined by the allocation determiner 41i (i.e., the coupon amount corresponding to the privilege determined by the privilege determiner 41g). The issue of the electronic coupon includes, for example, generation of the electronic coupon (coupon data) indicating the privilege determined by the privilege determiner 41g, assignment of a coupon ID to the electronic coupon, registration of management information of the electronic coupon (in the coupon information database 28), and provision of the electronic coupon to the target user. The management information of the electronic coupon includes the coupon ID, the common item code of the issue target item, the store item code of the issue target item, the maker code of a manufacturer that manufactures the issue target item, the store code of a store that sells the issue target item, the user ID of the target user, the issue time, the privilege (coupon amount) of the electronic coupon, the contributor and the contribution of the electronic coupon resources, and the validity period.

### 2. How Information Providing System S Works

The following describes how the information providing system S according to this embodiment works.

### 2-1. Estimated Viewing Duration Information Generation Process

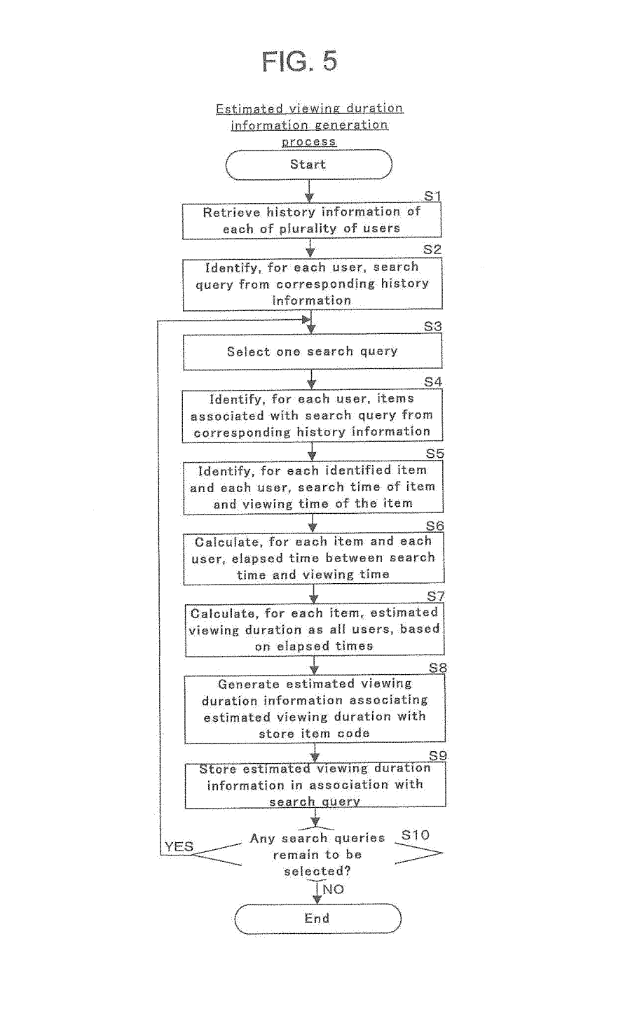

An estimated viewing duration information generation process performed by the system controller 4 of the information providing server SA will now be described with reference to FIG. 5. FIG. 5 is a flowchart showing an example of the estimated viewing duration information generation process performed by the system controller 4. The process shown in FIG. 5 is started at a time set by a timer at predetermined intervals (e.g., every twenty-four hours). When the process shown in FIG. 5 is started, the system controller 4 retrieves the history information of each of a plurality of users Un (e.g., all users Un) from the user information database 23 (Step S1). Subsequently, the system controller 4 identifies, for each user (i.e., user ID), a search query from the corresponding history information retrieved in Step S1 (Step S2).

Next, the system controller 4 selects one search query (or one search query group) from among the search queries identified in Step S2 (Step S3). The system controller 4 then identifies, for each user, items found by the search based on the search query (or one of the search query included in the search query group) selected in Step S3 (hereinafter, referred to as “items associated with the search query (or the search query group)”) from the above corresponding retrieved history information (e.g., by their store item codes) (Step S4).

Subsequently, the system controller 4 identifies, for each of the items (e.g., the store item codes) identified in Step S4 and each user, the search time of the item and the viewing time (viewing time at or after the corresponding search time) of the item, from the above corresponding retrieved history information (Step S5). The system controller 4 then calculates (counts), for each item and each user, the elapsed time between the search time and the viewing time that are identified in Step S5 (i.e., the time required between the search and the viewing) (Step S6).

The system controller 4 may determine an average viewing duration of each item (e.g., by averaging a plurality of viewing durations), based on the above retrieved history information, and the determined viewing duration (e.g., the duration for which detailed information about the item is being viewed through a web browser) and set the determined viewing duration as an upper limit (e.g., thirty minutes) for elapsed time to count. For example, assuming that the search time associated with a search query is 11:00, that the viewing time of an item (Item001) associated with the search query is 11:10, that the viewing time of an item (Item002) associated with the search query is 11:20, and that the viewing time of an item (Item003) associated with the search query is 16:10, the elapsed time of the item (Item001) and the elapsed time of the item (Item002) is respectively 10 minutes and 20 minutes. In contrast, the elapsed time of the item (Item003) is five hours. This is unnaturally long as compared with thirty minutes, which is an average viewing duration of an item, and its reliability as elapsed time data is low. Thus, setting an upper limit for elapsed time to count can provide more appropriate estimated viewing durations.

The upper limit for elapsed time to count is may be set for each user or each user base (segment) (e.g., average viewing durations vary from user or user or from user base to user base). Also for example, the upper limit for elapsed time to count may be set for each period of hours. For example, the upper limit for elapsed time to count is set to two hours for the hours from 20 to 2 (e.g., hours during which users usually make access) and set to be thirty minutes for the other hours. Also for example, the upper limit for elapsed time to count maybe set for each type of user terminal (e.g., personal computers (desktops) and mobile terminals). For example, the upper limit for elapsed time to count is set to two hours for personal computers and set to be thirty minutes for mobile terminals. In this case, the type of the corresponding user terminal is obtained at the time of the search or the viewing (e.g., from a cookie) and stored in the history information.

An item whose elapsed time calculated in Step S6 is less than (or less than or equal to) a predetermined period of time (threshold value: e.g., ten seconds) may be removed as noise. In this case, the elapsed time corresponding to the item is removed from an operation to calculate an estimated viewing duration in the following Step S7.

Subsequently, the system controller 4 calculates, for each item, an estimated viewing duration as all of the plurality of users, based on the elapsed times calculated for each user in Step S6 (Step S7). That is, based on the search time of each item and each user and on the viewing time of the item and the user, the system controller 4 calculates each item's elapsed time as all of the plurality of users to be an estimated viewing duration. For example, the average value or the standard deviation value of each user's elapsed times calculated in Step S6 is calculated for each item to be the estimated viewing duration as all of the plurality of users.

Next, the system controller 4 generates estimated viewing duration information associating the estimated viewing duration calculated for each item in Step S7 with the store item code of the item (Step S8). The system controller 4 then stores the estimated viewing duration information generated in Step S8 in association with the search query (or the search query group) selected in the above Step S3 in the estimated viewing information database 26 (Step S9). After that, the system controller 4 determines whether the search queries identified in Step S2 include any search queries yet to be selected in Step S3 (Step S10). If the system controller 4 determines that some search queries remain to be selected (YES in Step S10), the process returns to Step S3. The system controller 4 then performs the same steps as above for another search query. On the other hand, if it determines that no search query remains to be selected (NO in Step S10), the system. controller 4 terminates the process shown in FIG. 5.

After the process shown in FIG. 5 is started, the system controller 4 may classify the plurality of users into a plurality of user bases (segments) before Step S1, based on predetermined classification criteria (e.g., the above search durations (short, normal, and long) or important categories (image-oriented and text-oriented)), and retrieve, for each of the user bases, history information of each of a plurality of users who belongs to the user base in Step S1. In this case, the system controller 4 performs, for each of the user bases, Step S2 and subsequent steps, to calculate an estimated viewing duration for each of the user bases and generate estimated viewing duration information. The estimated viewing duration information thus generated is stored in association with the corresponding search query (or search query group) and with the corresponding user base in the estimated viewing information database 26. Thus, useful estimated viewing duration information that is more suitable for the above target user can be generated.

### 2-2. Estimated Viewing Order Information Generation Process

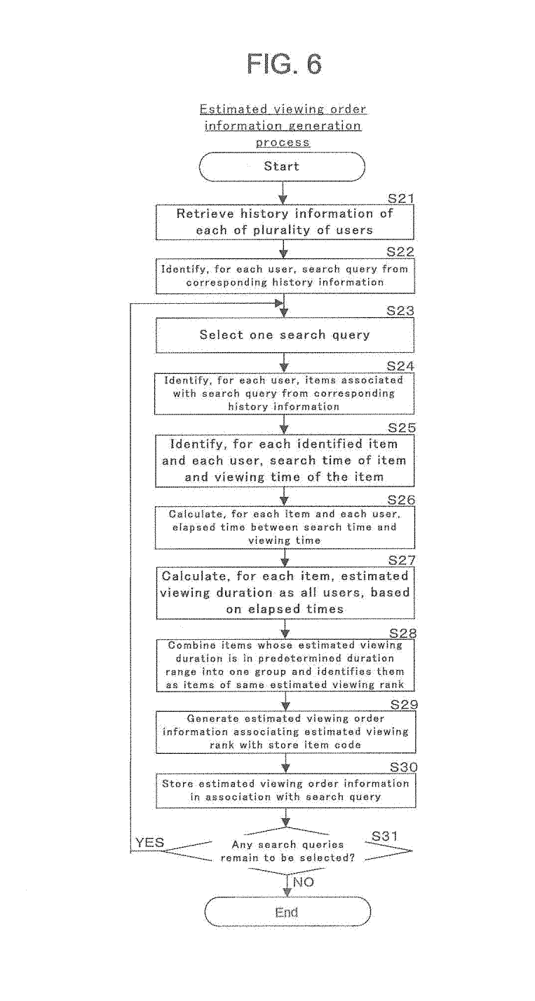

With reference to FIG. 6, the following describes an estimated viewing order information generation process performed by the system controller 4 of the information providing server SA. FIG. 6 is a flowchart showing an example of the estimated viewing order information generation process performed by the system controller 4. The process shown in FIG. 6 is started at a time set by a timer at predetermined intervals (e.g., every twenty-four hours). When the process shown in FIG. 6 is started, the system controller 4 retrieves the history information of each of a plurality of users Un (e.g., all users Un) from the user information database 23 (Step S21). Subsequently, the system controller 4 identifies, for each user (i.e., user ID), a search query from the corresponding history information retrieved in Step S21 (Step S22).

Next, the system controller 4 selects one search query (or one search query group) from among the search queries identified in Step S22 (Step S23). The system controller 4 then identifies, for each user, items associated with the search query (or the search query group) selected in Step S23 from the above corresponding retrieved history information (e.g., by their store item codes) (Step S24).

Subsequently, the system controller 4 identifies, for each of the items (e.g., the store item codes) identified in Step S24 and each user, the search time of the item and the viewing time (viewing time at or after the corresponding search time) of the item, from the above corresponding retrieved history information (Step S25). The system controller 4 then calculates (counts), for each item and each user, the elapsed time between the search time and the viewing time that are identified in Step S25 (i.e., the time required between the search and the viewing) (Step S26).

The system controller 4 may determine an average viewing duration of each item (e.g., by averaging a plurality of viewing durations), based on the above retrieved history information, and the determined viewing duration (e.g., the duration for which detailed information about the item is being viewed through a web browser) and set the determined viewing duration as an upper limit (e.g., thirty minutes) for elapsed time to count. For example, assuming that the search time associated with a search query is 11:00, that the viewing time of the item (Item001) associated with the search query is 11:10, that the viewing time of the item (Item002) associated with the search query is 11:20, and that the viewing time of the item (Item003) associated with the search query is 16:10, the elapsed time of the item (Item001) and the elapsed time of the item (Item002) is respectively 10 minutes and 20 minutes. In contrast, the elapsed time of the item (Item003) is five hours. This is unnaturally long as compared with thirty minutes, which is an average viewing duration of an item, and its reliability as elapsed time data is low. Thus, setting an upper limit for elapsed time to count can provide more appropriate estimated viewing durations.

The upper limit for elapsed time to count is may be set for each user or each user base (segment) (e.g., average viewing durations vary from user or user or from user base to user base). Also for example, the upper limit for elapsed time to count may be set for each period of hours. For example, the upper limit for elapsed time to count is set to two hours for the hours from 20 to 26 (e.g., hours during which users usually make access) and set to be thirty minutes for the other hours. Also for example, the upper limit for elapsed time to count may be set for each type of user terminal (e.g., personal computers (desktops) and mobile terminals). For example, the upper limit for elapsed time to count is set to two hours for personal computers and set to be thirty minutes for mobile terminals. In this case, the type of the corresponding user terminal is obtained at the time of the search or the viewing (e.g., from a cookie) and stored in the history information.

An item whose elapsed time calculated in Step S26 is less than (or less than or equal to) a predetermined period of time (threshold value: e.g., ten seconds) may be removed as noise. In this case, the elapsed time corresponding to the item is removed from an operation to calculate an estimated viewing duration in the following Step S27.

Subsequently, the system controller 4 calculates, for each item, an elapsed time as all of the plurality of users to be an estimated viewing duration, based on the elapsed times calculated for each user in Step S26 (Step S27). That is, based on the search time of each item and each user and on the viewing time of the item and the user, the system controller 4 calculates each item' s estimated viewing duration as all of the plurality of users. For example, the average value or the standard deviation value of each user's elapsed times calculated in Step S26 is calculated for each item to be the estimated viewing duration as all of the plurality of users.

Next, based on each item's estimated viewing duration calculated in Step S27, the system controller 4 combines items (e. g., store item codes) whose estimated viewing duration is in a predetermined duration range into one group and identifies them as items of the same estimated viewing rank (Step S28). That is, based on the viewing time of each item and each user, the system controller 4 identifies each item's estimated viewing rank (i.e., each item's estimated viewing rank as all of the plurality of users) so that the items are ranked in order of increasing viewing times (from oldest to newest). For example, a group including items whose estimated viewing duration is in the range of “0 to 10 minutes” is ranked first, a group including items whose estimated viewing duration is in the range of “10 to 20 minutes” is ranked second, a group including items whose estimated viewing duration is in the range of “20 to 30 minutes” is ranked third, and a group including items whose estimated viewing duration is in the range of “30 to 40 minutes” is ranked fourth. That is, in this example, the items are grouped together in 10 minutes (duration range unit) from the start of their estimated viewing durations. This duration range unit can be freely set. Thus, by grouping the items in a predetermined duration range unit, errors in the estimated viewing durations can be absorbed. Consequently, more appropriate estimated viewing ranks can be identified.

Alternatively, in Step S28, based on each item's estimated viewing duration calculated in Step S27, the system controller 4 may combine items between which there are relatively small differences in the estimated viewing duration (e.g., a difference of two minutes or less) into one item group and identify them as items of the same estimated viewing rank. For example, assuming that the elapsed time of the item (Item001) is one minute, that the elapsed time of the item (Item002) is five minutes, that the elapsed time of the item (Item003) is six minutes, that the elapsed time of an item (Item004) is ten minutes, and that the elapsed time of an item (Item005) is eleven minutes, a group including the item (Item001) is ranked first, a group including the item (Item002), the item (Item003), and the item (Item004) is ranked second, and a group including the item (Item004) and the item (Item005) is ranked third. This difference can be freely set. Thus, by grouping the items between which there are relatively small differences in the estimated viewing duration, errors in the estimated viewing durations can be absorbed. Consequently, more appropriate estimated viewing ranks can be identified.

Next, the system controller 4 generates estimated viewing order information associating the estimated viewing rank identified for each item in Step S28 with the store item code of the item (Step S29). The system controller 4 then stores the estimated viewing order information generated in Step S29 in association with the search query (or the search query group) selected in Step S23 in the estimated viewing information database 26 (Step S30). After that, the system controller 4 determines whether the search queries identified in Step S22 include any search queries yet to be selected in Step S23 (Step S31). If the system controller 4 determines that some search queries remain to be selected (YES in Step S31), the process returns to Step S23. The system controller 4 then performs the same steps as above for another search query. On the other hand, if it determines that no search query remains to be selected (NO in Step S31), the system controller 4 terminates the process shown in FIG. 6.

After the process shown in FIG. 6 is started, the system controller 4 may classify the plurality of users into a plurality of user bases (segments) before Step S21, based on predetermined classification criteria (e.g., the above search durations (short, normal, and long) or important categories (image-oriented and text-oriented)), and retrieve, for each of the user bases, history information of each of a plurality of users who belongs to the user base in Step S21. In this case, the system controller 4 performs, for each of the user bases, Step S22 and subsequent steps, to calculate each item's (each group's) estimated viewing rank and generate estimated viewing order information. The estimated viewing order information thus generated is stored in association with the corresponding search query (or search query group) and with the corresponding user base in the estimated viewing information database 26. Thus, useful estimated viewing order information that is more suitable for the above target user can be generated.

In the process shown in FIG. 6, the system controller 4 identifies estimated viewing ranks, based on each items estimated viewing duration. In another example, the system controller 4 may identify, for each user, each item's viewing rank (e.g., so that the items are ranked in order of increasing viewing times (from oldest to newest)), based on the viewing times identified for each user in Step S25 or the elapsed times identified for each user in Step S26. In this case, the system controller 4 identifies, for each item, the average value of the item's viewing ranks for the users as an estimated viewing rank. For example, when the item (Item003) for the user U1 ranks third, the item (Item003) for the user U2 ranks second, and the item (Item003) for the user U3 ranks first, the estimated viewing rank of the item (Item003) is second. Alternatively, the system controller 4 may identify the most common viewing order among the plurality of users as an estimated viewing order. For example, when the item (Item003) for the user U1 ranks third, the item (Item003) for the user U2 ranks third, and the item (Item003) for the user U3 ranks first, the estimated viewing rank of the item (Item003) is third. Alternatively, the system controller 4 may identify an estimated viewing rank only for items whose viewing ranks corresponding to a predetermined percentage (threshold value) or more of users are included in a predetermined rank range. For example, when the predetermined percentage is set to 50%, the predetermined rank range is set to five ranks, the item (Item003) for the user U1 ranks third, the item (Item003) for the user U2 ranks second, the item (Item003) for the user U3 ranks first, the item (Item003) for the user U4 ranks tenth, and the item (Item003) for the user U5 ranks twentieth, the viewing ranks of the item (Item003) for 50% or more of users U1 to U3 are in the predetermined rank range of five ranks. Thus, the estimated viewing rank of the item (Item003) is determined as described above. On the other hand, when the predetermined percentage is set to 50%, the predetermined rank range is set to top five, the item (Item003) for the user U1 ranks third, the item (Item003) for the user U2 ranks second, the item (Item003) for the user U3 ranks tenth, the item (Item003) for the user U4 ranks eighteenth, and the item (Item003) for the user U5 ranks twenty-sixth, the viewing ranks of the item (Item003) for 50% or more of users Un are not in the range of five ranks (in this case, the viewing ranks for the users U2 and U3 are in the range of five ranks, but the percentage thereof is two fifths, that is, less than 50%). Thus, the item (Item003) is outside the scope of determination of its estimated viewing rank. This allows items viewed in an irregular order to be removed as noise from the estimated viewing order. Consequently, more appropriate estimated viewing ranks can be identified. Such identification maybe applied to Step S28. In this case, as described above, when combining items whose estimated viewing duration is in the predetermined duration range into one group, the system controller 4 identifies, for each user, each item's viewing rank, and identifies an estimated viewing rank only for items whose viewing ranks corresponding to a predetermined percentage (e.g., 50%) or more of users are included in a predetermined rank range (e.g., in the range of five ranks forward or backward).

More specifically, after combining items whose estimated viewing duration is in the predetermined duration range into one group, the system controller 4 identifies, for each user, each item's viewing rank, and removes, from item groups whose estimated viewing rank has been identified, items whose viewing ranks corresponding to the predetermined percentage or more of users are not included in the predetermined rank range. Alternatively, before combining items whose estimated viewing duration is in the predetermined duration range into one group, the system controller 4 identifies, for each user, each item's viewing rank, and removes items whose viewing ranks corresponding to the predetermined percentage or more of users are not included in the predetermined rank range. After that, the system controller 4 combines the remaining items into the above group and identifies them as items of the same estimated viewing rank.

### 2-3. Electronic Coupon Issue Process (Pull-type)

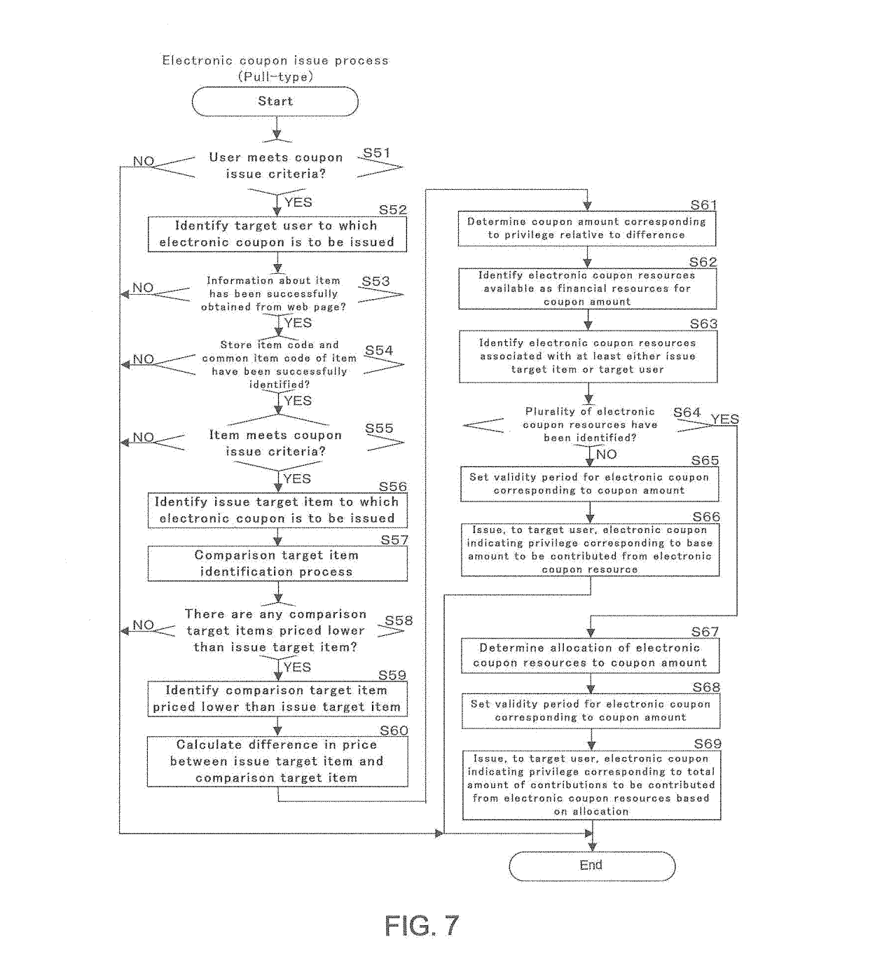

With reference to FIG. 7, the following describes an electronic coupon issue process (Pull-type) performed by the system controller 4 of the information providing server SA. FIG. 7 is a flowchart showing an example of the electronic coupon is sue process (Pull-type) performed by the system controller 4. The process shown in FIG.

7 is started after a login of the user U1 of the user terminal UT1 is performed in response to a login request from the user terminal UT1 that has accessed the information providing server SA. The login request may be made by a toolbar of the web browser. The toolbar is, for example, a belt-shaped area that is displayed on the top of a window of the web browser and in which buttons for performing various functions are placed. The information providing server SA identifies the user ID of the user U1 through the login of the user U1.

When the process shown in FIG. 7 is started, the system controller 4 of the information providing server SA determines whether the logged-in user U1 is a user who meets coupon issue criteria (Step S51). This determination is made, for example, by referring to the user rank, the history information, and other information stored in association with the user ID of the user U1 in the user information database 23. Examples of the coupon issue criteria include the following criteria (i) to (vii).
(i) The user rank of the user is a predetermined rank (e.g., Platinum member or higher).
(ii) The number of searches by the user within a predetermined period of time is greater than or equal to a predetermined number of times (threshold value) (e.g., the number of searches within the past week is ten or more).
(iii) The number of search queries by the user within a predetermined period of time is greater than or equal to a predetermined number (threshold value) (e.g., the number of search queries within the past week is twenty or more).
(iv) The number of views by the user within a predetermined period of time is greater than or equal to a predetermined number of times (threshold value) (e.g., the number of views within the past week is twenty or more).
(v) The viewing duration of the user within a predetermined period of time is greater than or equal to a predetermined duration (threshold value) (e.g., the total viewing duration within the past week is thirty minutes or more).
(vi) The purchase price paid by the user within a predetermined period of time is greater than or equal to a predetermined price (threshold value) (e.g., the purchase price within the past week is thirty thousand yen or more).
(vii) The number of purchases by the user within a predetermined period of time is greater than or equal to a predetermined number of times (threshold value) (e.g., the number of purchases within the past week is ten or more).

The number of search queries is the total number of search queries included in the search history associated with the user ID of the user U1. Alternatively, the number of search queries may be the number of search queries on which a search that found one or more items is based, among all the search queries included in the search history associated with the user ID of the user U1. Alternatively, the number of search queries may be obtained by counting the same search queries and similar or related search queries, among all the search queries included in the search history associated with the user ID of the user U1, as one search query.

If the system controller 4 determines that the user meets the coupon issue criteria (e.g., at least one of the above criteria (i) to (vii) (YES in Step S51), the process proceeds to Step S52. On the other hand, if it determines that the user does not meet the coupon issue criteria (NO in Step S51), the system controller 4 terminates the process shown in FIG. 7.

In Step S52, the system controller 4 (the target user identifying unit 41a) identifies the logged-in user U1 as a target user to which an electronic coupon is to be issued. Subsequently, the system controller 4 determines whether information about an item (e.g., the store item code, the name, and the price of the item) has been successfully obtained from a web page displayed by a web browser of the user terminal UT1 of the target user (the user U1, in this example) identified in Step S52 (Step S53). For example, for a web page (e.g., a web page indicating detailed information about an item) sent from the information providing server SA to the user terminal UT1, the system controller 4 can obtain information about the item (marketed by the store SHm) from the web page. On the other hand, even for a web page (e.g., a web page indicating detailed information about an item) sent from a server (another website) except the information providing server SA to the user terminal UT1, the system controller 4 can sometimes obtain information about the item (e.g., the name and the price of the item) from the web page via a toolbar of the web browser.

If the system controller 4 determines that information about an item has been successfully obtained (YES in Step S53), the process proceeds to Step S54. On the other hand, if it determines that no information about an item has been successfully obtained (NO in Step S53), such as when a web page for a non-item is being displayed, the system controller 4 terminates the process shown in FIG. 7.

In Step S54, the system controller 4 determines, based on the information about the item obtained in Step S53, whether the store item code and the common item code have been successfully identified. For example, when the information about the item has been obtained from the web page sent from the information providing server SA to the user terminal UT1, the store item code and the common item code of the item can be identified, for example, from the item information database 24. On the other hand, when the information about the item has been obtained from the web page sent from a server (another website) except the information providing server SA to the user terminal UT1, for example, if information about a competing item is preset in association with the name of this item (e.g., freely set by a system administrator), the store item code and the common item code of the competing item can be identified from the item information database 24. In this case, the item about which information has been obtained is an item to be a trigger for issue of an electronic coupon, and the competing item is a candidate issue target item.

If the system controller 4 determines that the store item code and the common item code have been successfully identified (YES in Step S54), the process proceeds to Step S55. On the other hand, if it determines that the store item code and the common item code have not been successfully identified (NO in Step S54), the system controller 4 terminates the process shown in FIG. 7.

In Step S55, the system controller 4 determines whether the item whose store item code and common item code have been successfully identified is an item that meets coupon issue criteria. This determination is made, for example, by referring to the stock quantity of the item, an advertising budget for the item, a sales target for the item, and the sales amount of the item that are stored in the maker information database 21 or the store information database 22. For example, if the stock quantity of the item is greater than or equal to a predetermined number (threshold: e.g., five), if the sales amount of the item is less than (or less than or equal to) the sales target (threshold), or if the stock quantity of the item is greater than or equal to a predetermined number and the sales amount of the item is less than (or less than or equal to) the sales target, it is determined that the item is an item that meets the coupon issue criteria.

If the system controller 4 determines that the item meets the coupon issue criteria (YES in Step S55), the process proceeds to Step S56. On the other hand, if it determines that the item does not meet the coupon issue criteria (NO in Step S55), the system controller 4 terminates the process shown in FIG. 7.

In Step S56, the system controller 4 (the issue target item identifying unit 41b) identifies the item determined to meet the coupon issue criteria in Step S55 as an issue target item for which an electronic coupon is to be issued, and stores information such as the store item code, the common item code, and the price of the identified issue target item in a predetermined area of the RAM. Subsequently, the system controller 4 (the comparison target item identifying unit 41c) performs a comparison target item identification process for identifying comparison target items to be compared with the issue target item identified in Step S56 (Step S57). Examples of the comparison target item identification process include the following (a) to (e).

### (a) Comparison Target Item Identification Process

### EXAMPLE 1

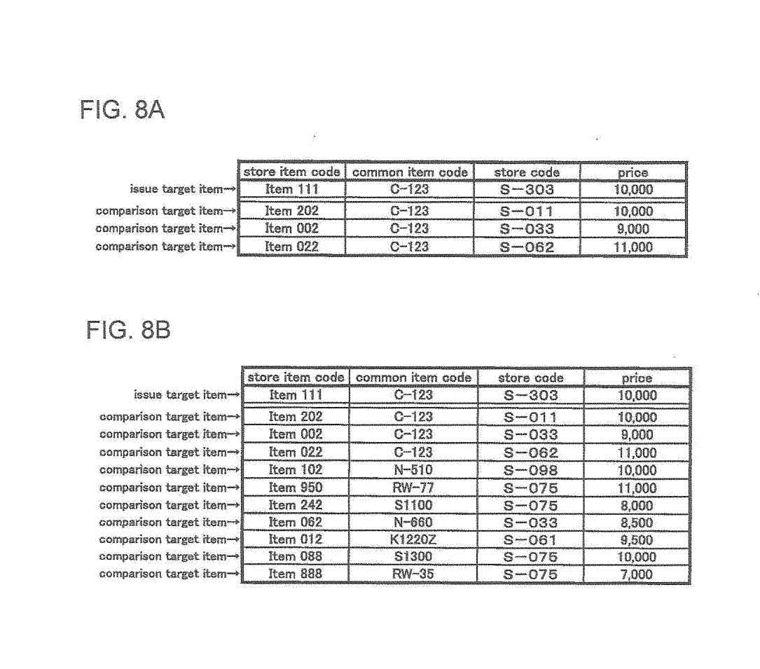

In a comparison target item identification process (Example 1), the system controller 4 identifies items whose common item code is the same as that of the issue target item and whose store item code is different from that of the issue target item as comparison target items from the item information database 24, and stores information such as the store item codes, the common item codes, and the prices of the identified comparison target items in a predetermined area of the RAM. FIG. 8A is a diagram showing a list of the store item code, the common item code, the store code, and the price of the issue target item identified in Step S56 and the store item codes, the common item codes, the store codes, and the prices of the comparison target items identified in the comparison target item identification process (Example 1). As shown in FIG. 8A, the common item code of the issue target item and the common item codes of the comparison target items are the same as each other.

### (b) Comparison Target Item Identification Process

### EXAMPLE 2

In a comparison target item identification process (Example 2), the system controller 4 identifies comparison target items whose common item code is the same as that of the issue target item and whose store item code is different from that of the issue target item as comparison target items as in the comparison target item identification process (a), and stores information such as the store item codes, the common item codes, and the prices of the identified comparison target items in a predetermined area of the RAM. Subsequently, the system controller 4 identifies items whose common item code is related to that of the issue target item and whose store item code is different from that of the issue target item as comparison target items from the item information database 24, and stores information such as the store item codes, the common item codes, and the prices of the identified comparison target items in a predetermined area of the RAM. For example, the system controller 4 retrieves the common item codes of related items, which are related to the issue target item, stored in association with the common item code of the issue target item in the related item database 25, and identifies comparison target items using the retrieved common item code from the item information database 24. FIG. 8B is a diagram showing a list of the store item code, the common item code, the store code, and the price of the issue target item identified in Step S56 and the store item codes, the common item codes, the store codes, and the prices of the comparison target items identified in the comparison target item identification process (Example 2). In the example of FIG. 8B, the common item codes of the comparison target items, N-510, RW-77, S1100, N-660, K1220Z, S1300, and RW-35, are each related to the comparison target item “C-123” of the issue target item.

### (c) Comparison Target Item Identification Process

### EXAMPLE 3

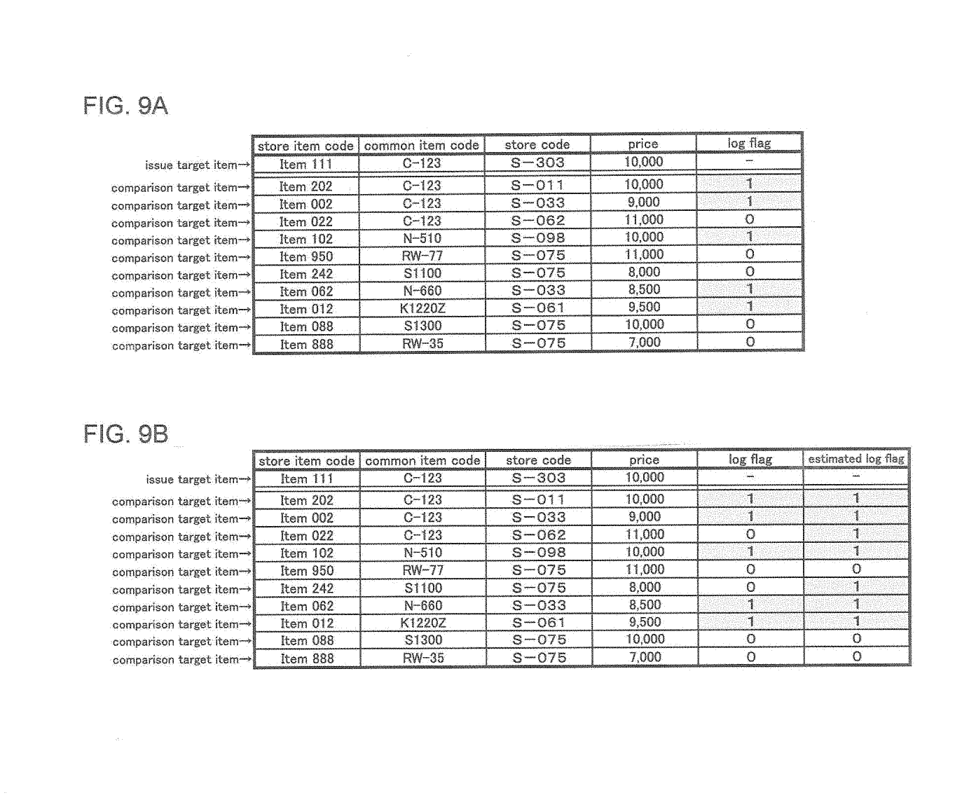

In a comparison target item identification process (Example 3), the system controller 4 identifies, as candidate comparison target items, items whose common item code is the same as that of the issue target item and whose store item code is different from that of the issue target item and items whose common item code is related to that of the issue target item and whose store item code is different fromthat of the issue target item, and stores information such as the store item codes, the common item codes, and the prices of the identified candidate comparison target items in a predetermined area of the RAM. Subsequently, the system controller 4 (the history information retriever 41d) retrieves the history information of the target user identified in Step S52 (the history information associated with the user ID of the target user) from the user information database 23, and identifies items from the search history, the viewing history, or the bookmark history included in the retrieved history information. Among the above identified candidate comparison target items, the system controller 4 identifies items identified from the history information as comparison target items, and stores a log flag of “1” in association with the store item codes of the identified comparison target items. Each log flag indicates whether the corresponding comparison target item was, for example, viewed by the target user. Among the above identified candidate comparison target items, the system controller 4 may identify items whose number of searches or number of views, which is identified from the history information (i.e., the search history or the viewing history), is greater than or equal to a predetermined number of times (threshold value) as comparison target items. Among the above identified candidate comparison target items, the system controller 4 may compare the search time (or the viewing time) of the issue target item with the search time (or the viewing time) of each of the items whose common item code is the same as or related to that of the issue target item, and then identify items whose difference between the times is less than (or less than or equal to) a predetermined difference (threshold value) as comparison target items. FIG. 9A is a diagram showing a list of the store item code, the common item code, the store code, and the price of the issue target item identified in Step S56 and the store item codes, the common item codes, the store codes, the prices, and the log flags of the comparison target items identified in the comparison target item identification process (Example 3). In the example of FIG. 9A, the items assigned store item codes associated with the log flag “1” are comparison target items.

### (d) Comparison Target Item Identification Process

### EXAMPLE 4

In a comparison target item identification process (Example 4), among the above identified candidate comparison target items, the system controller 4 identifies items identified from the history information as comparison target items, as in the comparison target item identification process (c), and stores a log flag in association with the store item codes of the identified comparison target items. Subsequently, the system controller 4 (the estimated viewed item identifying unit 41f) performs an estimated viewed item identification process, which will be described later, to identify estimated viewed items. Among the above identified candidate comparison target items, the system controller 4 identifies comparison target items identified by the estimated viewed item identification process as comparison target items, and stores an estimated log flag in association with the store item codes of the identified comparison target items. FIG. 9B is a diagram showing a list of the store item code, the common item code, the store code, and the price of the issue target item identified in Step S56 and the store item codes, the common item codes, the store codes, the prices, the log flags, and the estimated log flags of the comparison target items identified in the comparison target item identification process (Example 4). In the example of FIG. 9B, items not included in the history information are also stored in association with an estimated log flag of “1”.

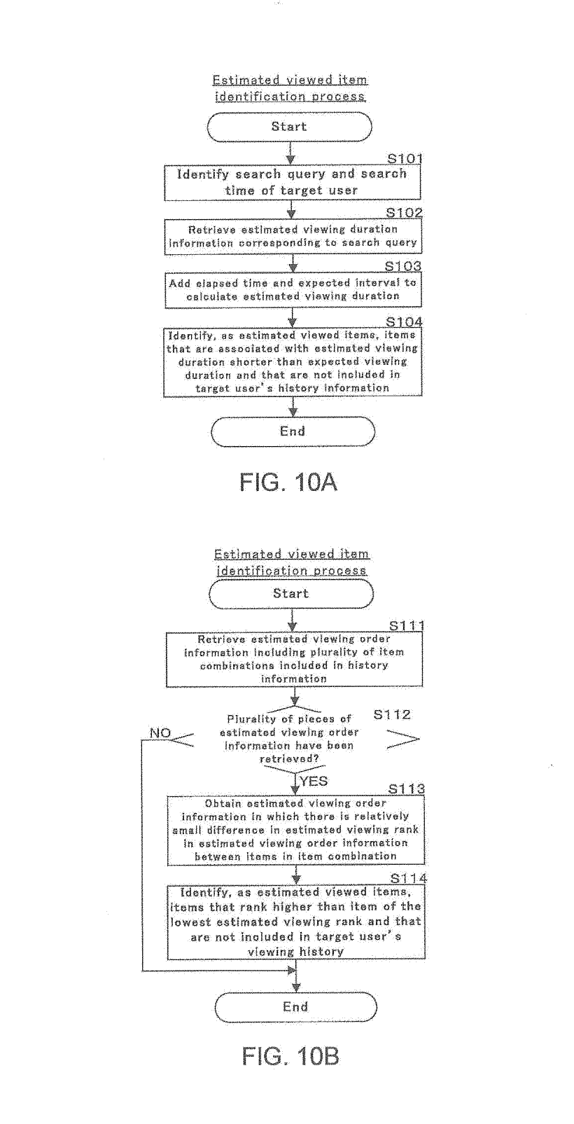

The estimated viewed item identification process will now be described with reference to FIG. 10. FIGS. 10A and 10B are each a flowchart showing an example of the estimated viewed item identification process. Either the estimated viewed item identification process shown in FIG. 10A or the estimated viewed item identification process shown in FIG. 10B may be performed. In the estimated viewed item identification process shown in FIG. 10A, the system controller 4 identifies, from the search history included in the history information of the target user identified in Step S52, a search query of the target user and the search time associated with the search query (Step S101). Subsequently, the system controller 4 (the estimated viewing information retriever 41e) retrieves the estimated viewing duration information corresponding to the search query identified in Step S101 from the estimated viewing information database 26, as described above (Step S102). Next, the system controller 4 adds the elapsed time between the search time identified in Step S101 and the current time (i.e., the time when this process is performed) to an expected interval between the current time and the target user's viewing, to calculate an expected viewing duration (Step S103). After that, the system controller 4 identifies, as estimated viewed items, items that are associated with an estimated viewing duration that is shorter than the expected viewing duration calculated in Step S103 and that are not included in the target user's history information, among the items included in the estimated viewing duration information retrieved in Step S102 (Step S104). The expected interval before viewing is determined as follows.

For example, the system controller 4 identifies, as the expected interval before the user U1's viewing, the reply interval between sending predetermined item information to the email address of the user U1 and receiving a predetermine reply from the user terminal UT1 of the user U1. This process is performed before the process shown in FIG. 7 is performed. The identified expected interval is stored in association with the user ID of the user U1 in the user information database 23. The above predetermined reply corresponds to, for example, a request that is sent from the user terminal UT1 to the information providing server SA when the user U1 specifies (e.g., with a mouse click or by a finger tap or the like) a uniform resource locator (URL) written in the body of a email received by the user terminal UT1 of the user U1 Alternatively, the above predetermined reply corresponds to, for example, a request that is sent from the user terminal UT1 to the information providing server SA when the user U1 specifies (e.g., with a mouse click or by a finger tap or the like) a download specification area for downloading content (e.g., an image) set in the above email (e.g., an HTML email) received by the user terminal UT1 of the user U1 There is a case where the predetermined reply can be identified even when the URL or the download specification area in the email is not specified. For example, the system controller 4 may identify, as the expected interval before the user U1's viewing, the reply interval between sending predetermined item information to the email address of the user U1 and access (an example of the predetermined reply) from a web browser of the user terminal UT1 of the user U1 to a predetermined website (a website provided by the information providing server SA) for the predetermined item information. Such a situation corresponds to, for example, a situation where the user U1's viewing of item information of interest in the email causes the web browser of the user terminal UT1 to start and access the above website.

As another example, the system controller 4 may identify, as the expected interval before the user U1's viewing, the reply interval between sending predetermined information (e.g., a pop-up message) to the toolbar to the web browser of the user terminal UT1 of the logged-in user U1 and access to a predetermined website (a website provided by the information providing server SA) that is made when the information is specified on the web browser. As described above, if an expected interval before the user U1's viewing is identified based on the reply interval between when the information providing server SA sends information to the user U1 and when a predetermined reply is received from the user terminal UT1 of the user U1, an expected interval based on how each user Un tends to react can be identified. Consequently, an expected viewing duration can be more correctly calculated. The system controller 4 may obtain the above reply interval more than once. In this case, the system controller 4 may identifies the average value, the minimum value, or the maximum value of the obtained reply intervals as the above expected interval.

As still another example, the expected interval before viewing may be, for example, the interval between the current time (i.e., the time when this process is performed) and the latest of high access times (hours) that are identified based on a history of usual access to the above website from the web browser of the user terminal UT1 of the user U1. In this case, the system controller 4 identifies some times (e.g., 7:00, 12:30, and 23:00) from hours (e.g., from 7 to 7:30, from 12:30 to 13, and from 23 to 24) during which the user relatively often accesses items, based on the user U1's history information, and identifies the interval between the current time (e.g., 22 p.m.) and the nearest (23) of the identified times as the expected interval before viewing. Also with this configuration, an expected interval based on how each user tends to react can be identified. Consequently, an expected viewing duration can be more correctly calculated.

On the other hand, in the estimated viewed item identification process shown in FIG. 10B, the system controller 4 (the estimated viewing information retriever 41e) retrieves, from the estimated viewing information database 26, estimated viewing order information including a plurality of item combinations included in the history information (i.e., the viewing history) of the target user identified in Step S52 (Step S111). As described above, the estimated viewing order information corresponding to a search query of the target user may be retrieved from the estimated viewing information database 26. Subsequently, the system controller 4 determines whether a plurality of pieces of estimated viewing order information have been retrieved in Step S111 (Step S112). If the system controller 4 determines that a plurality of pieces of estimated viewing order information have not been retrieved (i.e., one piece of estimated viewing order information has been retrieved) (NO in Step S112), the process proceeds to Step S114. On the other hand, if the system controller 4 determines that a plurality of pieces of estimated viewing order information have been retrieved (YES in Step S112), the process proceeds to Step S113.

In Step S113, from among the different pieces of estimated viewing order information, the system controller 4 obtains estimated viewing order information in which there is a relatively small difference in the estimated viewing rank in the estimated viewing order information between the items in an item combination included in the target user's viewing history. For example, in the viewing history shown in FIG. 4, the estimated viewing rank of the item assign the store item code Item202 is first in the estimated viewing order information and the estimated viewing rank of the item assign the store item code Item062 is fourth in the estimated viewing order information. Thus, the difference in the estimated viewing rank between these items is “three”. Estimated viewing order information, in which there is such a small difference in the estimated viewing rank, can be regarded as estimated viewing order information that is more suitable for the target user. Thus, estimated viewing order information that is more suitable for the target user can be obtained.

Alternatively, from among the different pieces of estimated viewing order information, the system controller 4 may obtain estimated viewing order information in which the viewing order in the viewing history of the items in an item combination included in the target user's viewing history are the same as the estimated viewing order in the estimated viewing order information of the items in the item combination. For example, in the viewing order of the items in an item combination in the viewing history shown in FIG. 4, the item assigned the store item code Item202 ranks first, the item assigned Item002 ranks second, the item assigned Item102 ranks third, the item assigned Item062 ranks fourth, and the item assigned Item012 ranks fifth. On the other hand, in the estimated viewing order in the estimated viewing order information of these items, the item assigned Item202 ranks first, the item assigned Item002 ranks first, the item assigned Item102 ranks second, the item assigned Item062 ranks fourth, and the item assigned Item012 ranks first. This means that the viewing order in the viewing history of the items in the item combination is not the same as the estimated viewing order in the estimated viewing order information of the items in the item combination. Estimated viewing order information in which the estimated viewing order is the same as the viewing order can be regarded as estimated viewing order information that is more suitable for the target user. Thus, also with this configuration, estimated viewing order information that is more suitable for the target user can be obtained. Alternatively, from among the different pieces of estimated viewing order information, the system controller 4 may obtain estimated viewing order information in which there is a relatively small difference in the estimated viewing rank in the estimated viewing order information between the items in an item combination included in the target user's viewing history and in which the viewing order in the viewing history of the items in the item combination included in the target user's viewing history are the same as the estimated viewing order in the estimated viewing order information of the items in the item combination. This enables estimated viewing order information that is much more suitable for the target user to be obtained.

In Step S114, the system controller 4 identifies, an item of the lowest estimated viewing rank (the item whose store item code is Item062, in the example of FIG. 4) among items that are included both in the target user's viewing history and in the estimated viewing order information retrieved in Step S111 or Step S113, and then identifies, as estimated viewed items, items that rank higher than the identified item and that are not included in the target user's viewing history, from the estimated viewing order information.

### (e) Comparison Target Item Identification Process

### EXAMPLE 5

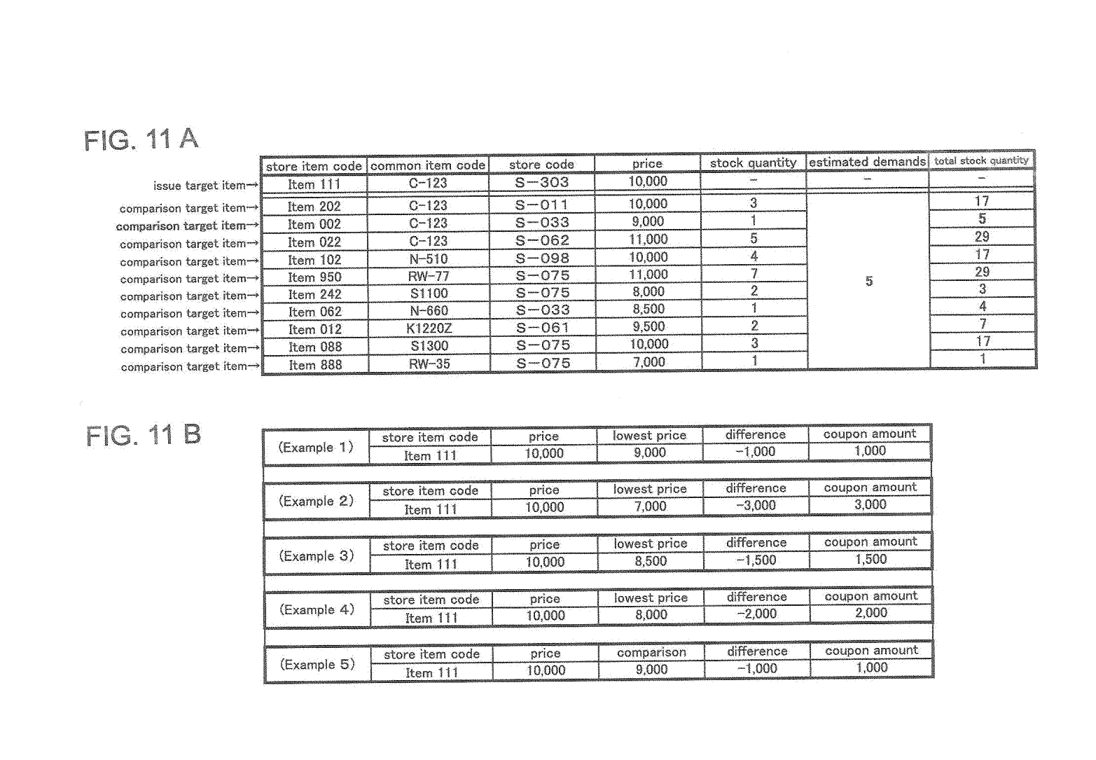

In a comparison target item identification process (Example 5), the system controller 4 identifies, as candidate comparison target items, items whose common item code is the same as that of the issue target item and whose store item code is different from that of the issue target item and items whose common item code is related to that of the issue target item and whose store item code is different fromthat of the issue target item, and stores information such as the store item codes, the common item codes, the prices, and the stock quantities of the identified candidate comparison target items in a predetermined area of the RAM. Subsequently, the system controller 4 adds up the stock quantity of each of the identified candidate comparison target items to calculate the total stock quantity. Next, the system controller 4 obtains the latest conversion rate. The conversion rate (the percentage of items that were purchased) is, for example, the proportion of items purchased by a plurality of users to items viewed on web pages by a plurality of users. Such a conversion rate can be calculated at predetermined intervals, for example, based on the viewing histories and the purchase histories of a plurality of users. Next, the system controller 4 multiplies the above calculated total stock quantity by the above obtained conversion rate to calculate an estimated number of demands. After that, the system controller 4 identifies, as comparison target items, items that cause the total stock quantity from cheaper items to become greater than or equal to the estimated number of demands, among the above identified candidate comparison target items. That is, the system controller 4 identifies, as comparison target items, items whose common item code is the same as or related to that of the issue target item and that cause the total stock quantity from cheaper items to become greater than or equal to the estimated number of demands. At this point, it is desirable that the cheapest of the items that cause the total stock quantity from cheaper items to become greater than or equal to the estimated number of demands be identified as the comparison target items. With this configuration, the most suitable comparison target items can be identified. FIG. 11A is a diagram showing a list of the store item code, the common item code, the store code, and the price of the issue target item identified in Step S56 and the store item codes, the common item codes, the store codes, the prices, the stock quantities, the estimated numbers of demands, and the total stock quantity of the comparison target items identified in the comparison target item identification process (Example 5). In the example of FIG. 11A, the cheapest of items that cause the total stock quantity from cheaper items (5) to become greater than or equal to the estimated number of demands (5) is the item whose store item code is Item002. This is because that identifying such items as comparison target items causes the issue target item to barely cut ahead of the comparison target items (i.e., to cut inside the estimated numbers of demands (5).

As described above, when a competing item of an item to be a trigger for issue of an electronic coupon are identified as the issue target item, the item to be a trigger is identified as a comparison target item in Step S57.

Subsequently, the system controller 4 determines whether the comparison target items identified in Step S57 include any comparison target items that are associated with a price lower than the price of the issue target item (Step S58). If it determines that some comparison target items are priced lower than the issue target item (YES in Step S58), the system controller 4 identifies a comparison target item priced lower than the issue target item (step S59). The process then proceeds to Step S60. On the other hand, if it determines that no comparison target item is priced lower than the issue target item (NO in Step S58), the system controller 4 terminates the process shown in FIG. 7. Even if no comparison target item is priced lower than the issue target item, an electronic coupon may be issued. Also in this case, a privilege relative to a price difference may be determined. In Step S60, the system controller 4 calculates the difference in price between the issue target item and the comparison target item identified in Step S59. When there are a plurality of identified comparison target items, the difference in price between the issue target item and each of the comparison target items is calculated.

Next, the system controller 4 (the privilege determiner 41g) determines a coupon amount corresponding to a privilege relative to the difference calculated in Step S60 (Step S61). When there are a plurality of identified comparison target items, the system controller 4 may determine a coupon amount corresponding to a privilege relative to the difference in price between the issue target item and the cheapest of the plurality of comparison target items. This enables determination of an appropriate coupon amount that is competitive with the comparison target item. FIG. 11B is a diagram showing an example coupon amount corresponding to a privilege relative to the difference in price from the cheapest (lowest-priced) of the comparison target items identified in each of the comparison target item identification processes (Example 1) to (Example 5).

When there are a plurality of identified comparison target items, the system controller 4 may determine a privilege (coupon amount) relative to the difference in price between the issue target item and a comparison target item that was selected a predetermined number of times or more (threshold value: five or more times within a predetermined period of time) in past comparisons with the issue target item by the target user, among the plurality of comparison target items. This also enables determination of an appropriate coupon amount that is competitive with the comparison target item. The comparison target item selected in the past comparisons corresponds to, for example, a comparison target item selected by a viewing operation of the target user from a list of the issue target item and comparison target items that is being displayed so as to be available for selection on a web page showing past search results based on a search query of the target user. A history of selecting items in such a situation can be identified from the target user's history information. If a comparison target item was selected in a past comparison between the issue target item and the comparison target item, this means that issue target item lost in the comparison. On the other hand, if the issue target item was selected in the past comparison between the issue target item and the comparison target item, this means that issue target item won in the comparison. The comparison target item against which the issue target item wins or loses is a rival item. That is, the comparison target item and the issue target item are in rivalry with each other. In particular, the system controller 4 may identify a comparison target item that has a winning percentage of greater than or equal to 20% and less than 50% against the issue target item as a rival item, and determine a privilege relative to the difference in price between the identified rival item and the issue target item. This means that items that one-sidedly defeat the issue target item are excluded. The rival item may be freely set by a store SHm that sells the issue target item or a maker Ml that manufactures the issue target item, and be stored in any of the above databases. Alternatively, the rival item may be freely set by a financial resource provider, and be stored in any of the above databases.

When a predetermined condition is met, such as when the comparison target item on which determination of the privilege is based is a rival item, when the target user is a regular customer of the store SHm that sells the issue target item, and when item distribution (item transaction) shows a slowdown trend, the system controller 4 may determine the amount obtained by adding a predetermined amount to the difference calculated in Step S60 to be the coupon amount. The regular customer corresponds to, for example, a user Un whose purchase price at the store SHm that sells the issue target item is greater than or equal to a predetermined amount (threshold value) or whose number of purchases at the store is greater than or equal to a predetermined number of times (threshold value). The slowdown trend in item distribution corresponds to, for example, a case where the total sale of all items (all items stored in the item information database 24) within a predetermined period of time (e.g., a week) shows a downward trend or a case where the total sales volume of all items shows a downward trend.

Subsequently, the system controller 4 (the financial resource identification unit 41h) identifies, from the financial resource information database 27, electronic coupon resources that are available as financial resources for the coupon amount determined in Step S61 (Step S62). For example, the systemcontroller 4 identifies, as available electronic coupon resources, electronic coupon resources whose remaining budget is greater than or equal to a base amount, among the electronic coupon resources stored in the financial resource information database 27. That is, electronic coupon resources that meet base amount criteria (criteria 1) for electronic coupon resources are identified (determined) to be available. If no available electronic coupon resources are identified in Step S62, the process shown in FIG. 7 ends.

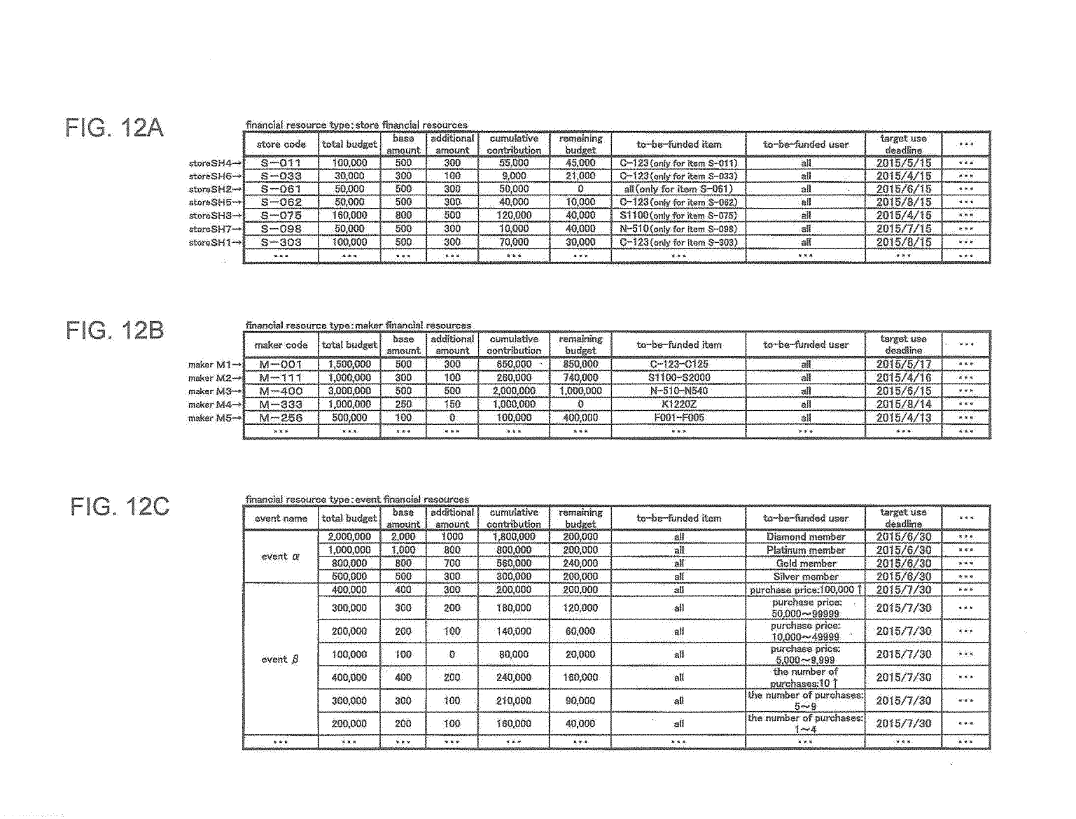

FIG. 12 is a diagram showing an example of information stored in the financial resource information database 27. In the example of FIG. 12A, the financial resource type indicates store financial resources. In the example of FIG. 12B, the financial resource type indicates maker financial resources. In the example of FIG. 12C, the financial resource type indicates event financial resources. For example, for the store SH1 whose store code is S-303, its base amount for electronic coupon resources is ¥500 and its remaining budget is ¥30, 000. Thus, the store SH1's electronic coupon resources are identified as available electronic coupon resources. In addition to this, in the example of FIGS. 12A, 12B, and 12C, other electronic coupon resources except the store M4's electronic coupon resources and the maker M4's electronic coupon resources are also identified as available electronic coupon resources. In Step S62, instead of the base amount criteria 1 for electronic coupon resources or together with (i.e., in addition to) the base amount criteria, other criteria for determining available electronic coupon resources may be set. For example, the system controller 4 identifies, as available electronic coupon resources, electronic coupon resources whose remaining budget is greater than or equal to a predetermined amount (threshold value: e.g., one third of the remaining budget) (criteria 2). Alternatively, for example, the system controller 4 identifies, as available electronic coupon resources, electronic coupon resources whose progress rate until the target use deadline of the electronic coupon resources is less than (or less than or equal to) a predetermined percentage (threshold value: e.g., 50%) (criteria 3). Alternatively, for example, the system controller 4 identifies, as available electronic coupon resources, electronic coupon resources provided by a financial resource provider (e.g., a store SHm or a maker Ml) whose sales is less than (or less than or equal to) a predetermined amount (criteria 4). Alternatively, for example, the system controller 4 identifies, as available electronic coupon resources, electronic coupon resources provided by a financial resource provider (e.g., a store SHm or a maker Ml) whose progress rate to its sales target is less than (or less than or equal to) a predetermined percentage (e.g., 50%) (criteria 5). Alternatively, the system controller 4 may combine any two or more of the above criteria 1 to 5 using AND to identify available electronic coupon resources.

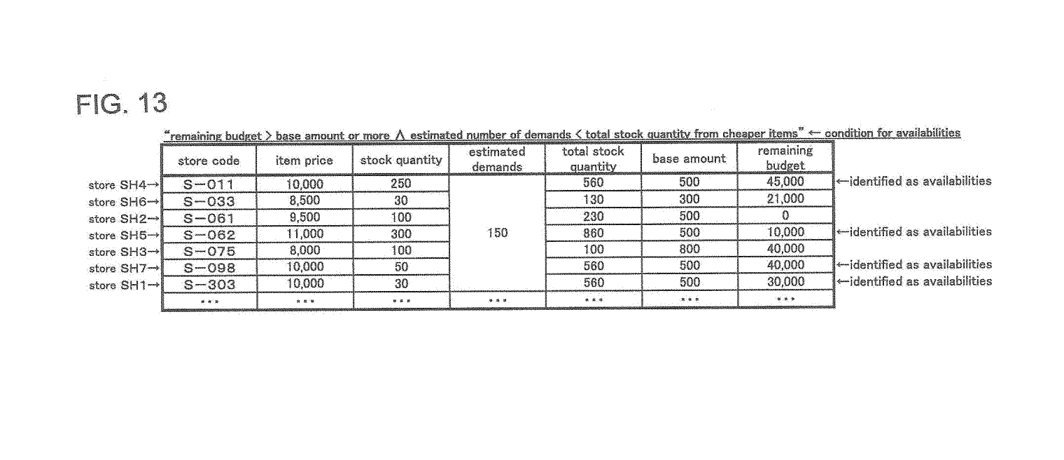

As another example, the system controller 4 may identify, as available electronic coupon resources, electronic coupon resources whose remaining budget is greater than or equal to a base amount and that is provided by a financial resource provider whose total stock quantity from cheaper items (the issue target item and the comparison target items) exceeds the estimated number of demands. FIG. 13 is a diagram showing a list of store codes, the prices of items, the stock quantities of the items, estimated numbers of demands for the items, total stock quantities, base amounts, and remaining budgets. In the example of FIG. 13, electronic coupon resources of the store SH4, the store SHS, the store SH7, and the store SH1 are identified as available electronic coupon resources. For example, the item whose total stock quantity from cheaper items is less than the estimated number of demands and that the store SH6 sells is highly likely to be sold even if no electronic coupon is issued. Thus, the item needs no contribution from the store SH6's electronic coupon resources. That is the reason why the store SH6's electronic coupon resources are not identified as available electronic coupon resources.

Subsequently, the system controller 4 (the financial resource identification unit 41h) identifies, from the financial resource information database 27, electronic coupon resources that are associated with at least either the above issue target item or the above target user, among the electronic coupon resources identified in Step S62 (Step S63). For example, the issue target item (store item code: Item111, common item code: C-123) is an item that is sold by the store SH1 whose store code is S-303, and is indicated by the to-be-funded item of the store SH1′ electronic coupon resources as shown in FIG. 12A. Thus, in Step S63, the store SH1's electronic coupon resources are identified as electronic coupon resources associated with the issue target item (linked with the issue target item). In this example, no other store financial resources are identified in Step S63. The issue target item (store item code: Item111, common item code: C-123) is an item that is manufactured by the store M1 whose maker code is M-001, and is indicated by the to-be-funded item of the store M1′ electronic coupon resources as shown in FIG. 12B. Thus, in Step S63, the maker Ml's electronic coupon resources are identified as electronic coupon resources associated with the issue target item. In this example, no other maker financial resources are identified in Step S63. If the user rank of the target user is Silver member, the user is indicated by the to-be-funded user of an event α's electronic coupon resource (whose total budget is ¥500,000) as shown in FIG. 12C. Thus, in Step S63, the event a's electronic coupon resource (whose total budget is ¥500,000) are identified as electronic coupon resources associated with the target user (linked with the target user). The user rank of the target user is identified using the user ID of the target user as a key from the user information database 23. If there is no purchase history within the past predetermined period of time (e.g., within the past week) in the system S, an event β's electronic coupon resource shown in FIG. 12C may not be identified. If no available electronic coupon resources are identified in Step S63, the process shown in FIG. 7 ends.

Next, the system controller 4 determines whether a plurality of electronic coupon resources have been identified in Step S63 (Step S64). If the system controller 4 determines that a plurality of electronic coupon resources have not been identified (NO in Step S64), the process proceeds to Step S65. In Step S65, the system controller 4 sets a validity period for an electronic coupon indicating the privilege corresponding to the coupon amount determined in Step S61. Next, the system controller 4 issues, to the target user, an electronic coupon indicating a privilege corresponding to the base amount (or the sum of the base amount and the additional amount) to be contributed from the identified electronic coupon resource (Step S66), and then terminates the process shown in FIG. 7.

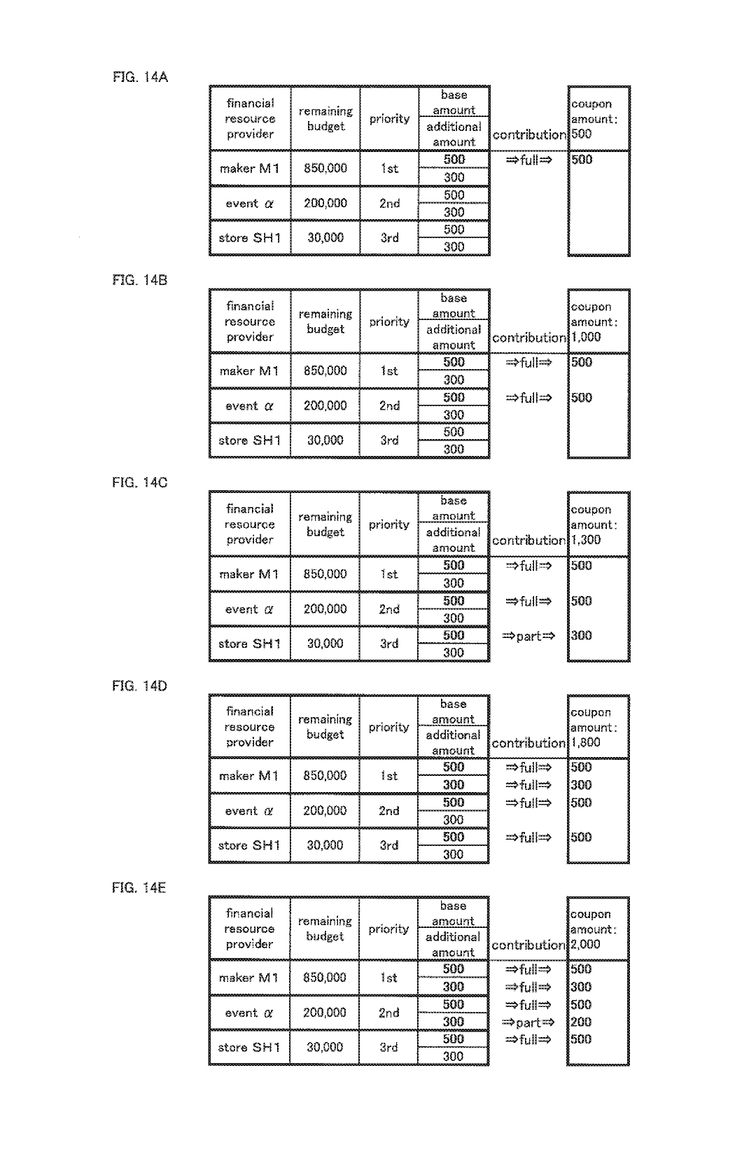

On the other hand, if it determines that a plurality of electronic coupon resources have been identified (YES in Step S64), the system controller 4 (the allocation determiner 41i) determines the allocation of electronic coupon resources to the coupon amount determined in Step S61, based on the plurality of electronic coupon resources identified in Step S63 (Step S67). For example, the system controller 4 preferentially allocates electronic coupon resources having a relatively large remaining budget to the coupon amount. That is, the higher the remaining budget, the higher the priority of the allocation is determined to be. FIGS. 14A to 14E are each a diagram illustrating an example where electronic coupon resources having a relatively large remaining budget are preferentially allocated. As illustrated in FIG. 14A, assuming that three electronic coupon resources are identified in Step S63, that the coupon amount is ¥500, and that the base amounts of the three electronic coupon resources are each ¥500, only ¥500 of the electronic coupon resource having the largest remaining budget (the maker M1's electronic coupon resource given the first priority) is allocated to the coupon amount, and no other electronic coupon resources are allocated. As illustrated in FIG. 14B, assuming that three electronic coupon resources are identified in Step S63, that the coupon amount is ¥1,000, and that the base amounts of the three electronic coupon resources are each ¥500, ¥500 (the full base amount) of the electronic coupon resource having the largest remaining budget and ¥500 (the full base amount) of the electronic coupon resource (the event α's electronic coupon resource given the second priority) having the second largest remaining budget are allocated to the coupon amount, and the electronic coupon resource (the store SH1's electronic coupon resource given the third priority) having the smallest remaining budget is not allocated. As illustrated in FIG. 14C, assuming that three electronic coupon resources are identified in Step S63, that the coupon amount is ¥1,300, and that the base amounts of the three electronic coupon resources are each ¥500, ¥500 (the full base amount) of the electronic coupon resource having the largest remaining budget, ¥500 (the full base amount) of the electronic coupon resource having the second largest remaining budget, ¥300 of (part of the base amount) of the electronic coupon resource having the smallest remaining budget are allocated to the coupon amount. As illustrated in FIG. 14D, assuming that three electronic coupon resources are identified in Step S63, that the coupon amount is ¥1,800, that the base amounts of the three electronic coupon resources are each ¥500, and that the additional amounts of the three electronic coupon resources are each ¥300, ¥500 (the full base amount) of the electronic coupon resource having the largest remaining budget, ¥500 (the full base amount) of the electronic coupon resource having the second largest remaining budget, ¥500 of (the full base amount) of the electronic coupon resource having the smallest remaining budget are allocated to the coupon amount, but these are still not enough. Thus, ¥300 (the full additional amount) of the electronic coupon resource having the largest remaining budget is also allocated to the coupon amount. As illustrated in FIG. 14E, assuming that three electronic coupon resources are identified in Step S63, that the coupon amount is ¥2,000, that the base amounts of the three electronic coupon resources are each ¥5006, and that the additional amounts of the three electronic coupon resources are each ¥300, ¥500 (the full base amount) of the electronic coupon resource having the largest remaining budget, ¥500 (the full base amount) of the electronic coupon resource having the second largest remaining budget, ¥500 of (the full base amount) of the electronic coupon resource having the smallest remaining budget are allocated to the coupon amount, but these are still not enough. Thus, ¥300 (the full additional amount) of the electronic coupon resource having the largest remaining budget and ¥200 (part of the additional amount) of the electronic coupon resource having the second largest remaining budget are also allocated to the coupon amount.

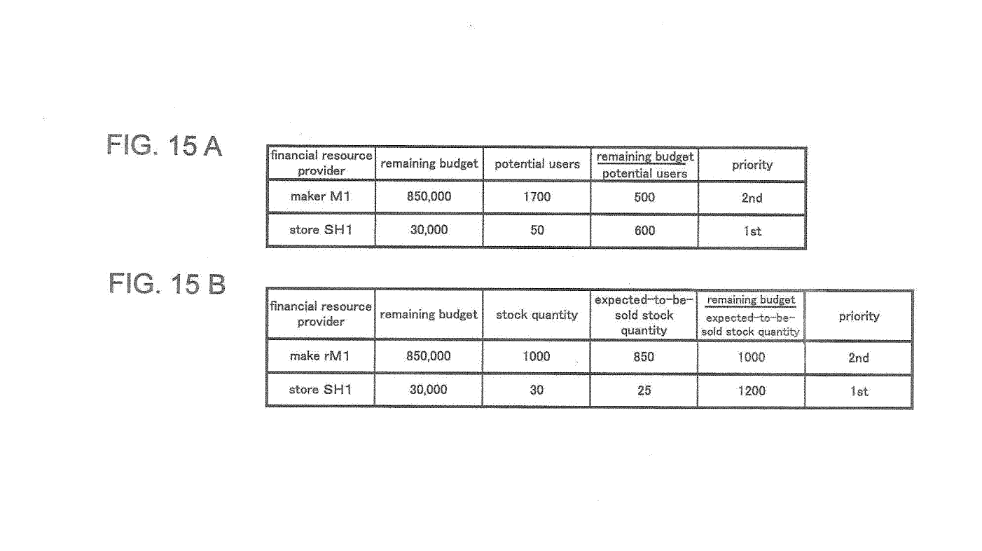

However, if electronic coupon resources having a relatively large remaining budget are preferentially allocated as described above when there is a wide difference in total budget between the electronic coupon resources, it is not fair because only electronic coupon resources having a larger total budget are allocated. For example, as shown in FIG. 12, the total budget of any maker Ml's electronic coupon resource is larger than the total budget of any store SHm's electronic coupon resource when they are compared with each other. Thus, for example, the system controller 4 may make the comparison after dividing the remaining budget of the electronic coupon resource of each financial resource provider by the number of potential users associated with the financial resource provider. The number of potential users is the number of potential users Un of the financial resource provider. For example, the system controller 4 identifies, for each financial resource provider, the number of potential users of the financial resource provider of each of the plurality of electronic coupon resources in Step S63, and calculates the remaining budget of each financial resource provider's electronic coupon resource per predetermined unit number of users Un (i.e., the remaining budget divided by the number of potential users), based on the identified number of potential users of each financial resource provider. The system controller 4 then preferentially allocates, to the coupon amount, electronic coupon resources whose remaining budget per the above predetermined unit number is relatively large. FIG. 15A is a diagram illustrating an example where electronic coupon resources whose remaining budget divided by the corresponding number of potential users (the remaining budget per the predetermined unit number of users Un) is relatively large are preferentially allocated. In the example of FIG. 15A, whereas the remaining budget of the maker M1's electronic coupon resource divided by its number of potential users is ¥500, the remaining budget of the store SH1's electronic coupon resource divided by its number of potential users is ¥600. Thus, in this example, the store SH1's electronic coupon resource is allocated in preference to the maker M1's electronic coupon resource. This enables a fair allocation of electronic coupon resources even when there is a wide difference in initial total budget between the electronic coupon resources. The number of potential users of a financial resource provider is identified, for example, as the number of users who searched for any item sold (marketed) or manufactured by the financial resource provider or the number of users who have bookmarked any item sold (marketed) or manufactured by the financial resource provider. These numbers of users Un can be identified by counting, for each store code or each maker code, the number of records containing the store code or the maker code included in the search history, the viewing history, or the bookmark history of each user Un stored in the user information database 23.

Alternatively, for example, the system controller 4 may make the comparison after dividing the remaining budget of the electronic coupon resource of each financial resource provider by the item stock quantity associated with the financial resource provider. The item stock quantity is the stock quantity of the issue target item or a stock quantity relative to the expectation that the issue target item will be sold (hereinafter, referred to as an “expected-to-be-sold stock quantity”) in the stock quantity of the issue target item. The expected-to-be-sold stock quantity is the number of items whose transactions are expected to be closed. For example, the system controller 4 identifies, for each financial resource provider, an expected-to-be-sold stock quantity of the issue target item that is sold or manufactured by the financial resource provider of each of the plurality of electronic coupon resources in Step S63, and calculates the remaining budget of each financial resource provider's electronic coupon resource per predetermined unit number of expected-to-be-sold stock items (i.e., the remaining budget divided by the expected-to-be-sold stock quantity), based on the identified expected-to-be-sold stock quantity of each financial resource provider. The system controller 4 then preferentially allocates, to the coupon amount, electronic coupon resources whose remaining budget per the above predetermined unit number is relatively large. FIG. 15B is a diagram illustrating an example where electronic coupon resources whose remaining budget divided by the corresponding expected-to-be-sold stock quantity (the remaining budget per the predetermined unit number of expected-to-be-sold stock items) is relatively large are preferentially allocated. In the example of FIG. 15B, whereas the remaining budget of the maker M1's electronic coupon resource divided by its expected-to-be-sold stock quantity is ¥1,000, the remaining budget of the store SH1's electronic coupon resource divided by its expected-to-be-sold stock quantity is ¥1,200. Thus, in this example, the store SH1's electronic coupon resource is allocated in preference to the maker M1's electronic coupon resource. This enables a fair allocation of electronic coupon resources even when there is a wide difference in initial total budget between the electronic coupon resources. The expected-to-be-sold stock quantity of the issue target item can be identified, for example, as an estimated sales volume that is calculated based on the previous actual sales of the issue target item. The expected-to-be-sold stock quantity of the issue target item may be identified further in view of the pieces of history information of the users Un. For example, the expected-to-be-sold stock quantity of the issue target item maybe identified as the number of times that the issue target items was searched for or an estimated sales volume that is calculated based on the actual sales throughout a period during which changes in the number of times that the issue target items was searched for show a same trend. Alternatively, the expected-to-be-sold stock quantity of the issue target item may be identified as the number of times that the issue target items was viewed or an estimated sales volume that is calculated based on the actual sales throughout a period during which changes in the number of times that the issue target items was viewed show a same trend. Alternatively, the expected-to-be-sold stock quantity of the issue target item may be identified as the number of times that the issue target items was bookmarked or an estimated sales volume that is calculated based on the actual sales throughout a period during which changes in the number of times that the issue target items was bookmarked show a same trend.

Alternatively, the system controller 4 may preferentially allocate, to the coupon amount, electronic coupon resources that have a relatively large amount of electronic coupon resource (total budget or remaining budget) distributed to an item category to which the above issue target item belongs. This allows for more efficient use of electronic coupon resources depending on which item category the issue target item belongs to. Alternatively, the system controller 4 may preferentially allocate, to the coupon amount, the electronic coupon resources that have a relatively large amount of electronic coupon resource (total budget or remaining budget) distributed to a user base to which the above target user belongs. This allows for more efficient use of electronic coupon resources depending on which user base the target user belongs to. The system controller 4 may determine the allocation of electronic coupon resources to the above coupon amount, based on the target use deadline of each of the plurality of electronic coupon resources identified in Step S63. For example, the system controller 4 calculates, for each financial resource provider, the remaining budget of its electronic coupon resource per unit days that is obtained by dividing the remaining budget of each of the plurality of electronic coupon resources identified in Step S63 by the corresponding remaining number of available days (the number of days from the current time to the target use deadline). The system controller 4 then preferentially allocates, to the coupon amount, electronic coupon resources whose remaining budget per the above unit days is relatively large. This allows for more efficient use of electronic coupon resources depending on how many available days are left until the target use deadline. The remaining budget of an electronic coupon resource per unit days may be calculated for each item category.

Subsequently, the system controller 4 (the validity period setting unit 41j) sets a validity period for an electronic coupon indicating the privilege corresponding to the coupon amount determined in Step S61 (Step S68). For example, the validity period for the electronic coupon is set to a predetermined period (e.g., a few hours). Alternatively, the system controller 4 may identify a considering duration for the issue target item, based on the history information of each of a plurality of users Un who viewed the above issue target item, and set a validity period (e.g., set the validity period to the considering duration (e.g., thirty minutes)) for the above electronic coupon, based on the identified considering duration (e.g., thirty minutes). The considering duration is the average value, the minimum value, or the maximum value of the viewing durations (the viewing durations for the issue target item) identified from the history information of each of the plurality of user Un. This can give a minimum time required to consider whether to purchase the issue target item to the target user to which the electronic coupon was provided, and efficiently prompt the user to purchase the item. Alternatively, the system controller 4 may identify changes in the number of accesses from a plurality of user Un stored in the user information database 23 to a predetermined item and identify an estimated period required for the number of accesses to become greater than or equal to a predetermined number (threshold value) from the identified changes. In this case, based on the identified estimated period, the system controller 4 sets a validity period for the electronic coupon indicating the privilege corresponding to the coupon amount determined in Step S61 (e.g., sets the validity period to the estimated period). This can prompt the target user to which the electronic coupon was provided to purchase the issue target item before the number of accesses to the item exceeds a certain level. The number of accesses to the predetermined item is the number of accesses to all the items stored in the item information database 24, the number of accesses to items in an item category to which the issue target item belongs, or the number of accesses to items whose common item code is the same as or related to that of the issue target item. Such number of accesses is identified, for example, as the total number of searches or the total number of views for the above item included in the history information of each of a predetermined number of users Un.

Subsequently, the system controller 4 (the coupon issuer 41k) issues, to the target user identified in Step S52, an electronic coupon indicating the privilege corresponding to the total amount of contributions to be contributed from the electronic coupon resources based on the allocation determined in Step S66 (i.e., the coupon amount corresponding to the privilege determined by the privilege determiner 41g) (Step S69), and then terminates the process shown in FIG. 7. As described above, the issue of the electronic coupon includes generation of the electronic coupon indicating the privilege corresponding to the coupon amount determined in Step S61, assignment of a coupon ID to the electronic coupon, registration of management information of the electronic coupon, and provision of the electronic coupon to the target user. In the provision of the electronic coupon to the target user, for example, the electronic coupon is sent from the system controller 4 to the web browser of the user terminal UT1 of the target user or to the email address of the target user. The electronic coupon sent to the web browser of the user terminal UT1 is popped up in a window of the web browser or displayed on the toolbar of the web browser, and then becomes available in payment for purchase of the issue target item by the target user. A contribution to be contributed from each electronic coupon resource is added to the cumulative contribution of the electronic coupon resource and is also subtracted from the remaining budget of the electronic coupon resource. The cumulative contribution and the remaining budget are then stored in the financial resource information database 27 to update the corresponding entries. When an electronic coupon resource distributed to an item category to which the issue target item belongs is allocated, a contribution is subtracted from the remaining budget of the electronic coupon resource distributed to the item category. Alternatively, when an electronic coupon resource distributed to a user base to which the target user belongs is allocated, a contribution is subtracted from the remaining budget of the electronic coupon resource distributed to the user base.

### 2-4. Electronic Coupon Issue Process (Push-type)

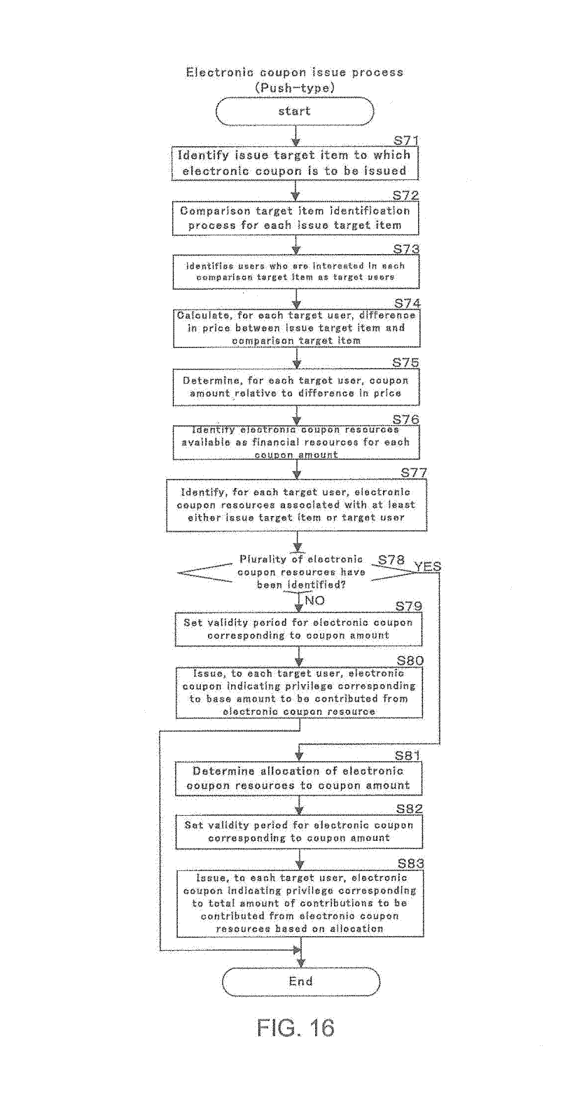

With reference to FIG. 16, the following describes an electronic coupon issue process (Push-type) performed by the system controller 4 of the information providing server SA. FIG. 16 is a flowchart showing an example of the electronic coupon issue process (Push-type) performed by the system controller 4. For example, the system controller 4 determines at predetermined intervals whether a start condition of the electronic coupon issue process is met. If it determines that the start condition of the electronic coupon issue process is met, the system controller 4 starts the process shown in FIG. 16. Examples of the start condition include the following conditions (I) to (VII).
(I) A time set by a timer has come.
(II) The advertising budget for items stored in the item information database 24 (e.g., the total for all or some items) has changed (especially, increased) by a predetermined amount within a predetermined period of time.
(III) The stock quantity of items stored in the item information database 24 (e.g., the total for all or some items) has changed (especially, increased) by a predetermined quantity within a predetermined period of time.
(IV) The number of times that items stored in the item information database 24 were searched for (e.g., the total for all or some items) has increased by a predetermined number within a predetermined period of time.
(V) The number of times that items stored in the item information database 24 were viewed (e.g., the total for all or some items) has increased by a predetermined number within a predetermined period of time.
(VI) The sales of items stored in the item information database 24 during a predetermined period of time (e.g., the total for all or some items) have decreased by a predetermined amount as compared with those during another predetermined period to be compared.
(VII) The rate of increase in the sales of items stored in the item information database 24 during a predetermined period of time (e.g., the total for all or some items) have decreased by a predetermined value as compared with that during another predetermined period to be compared.

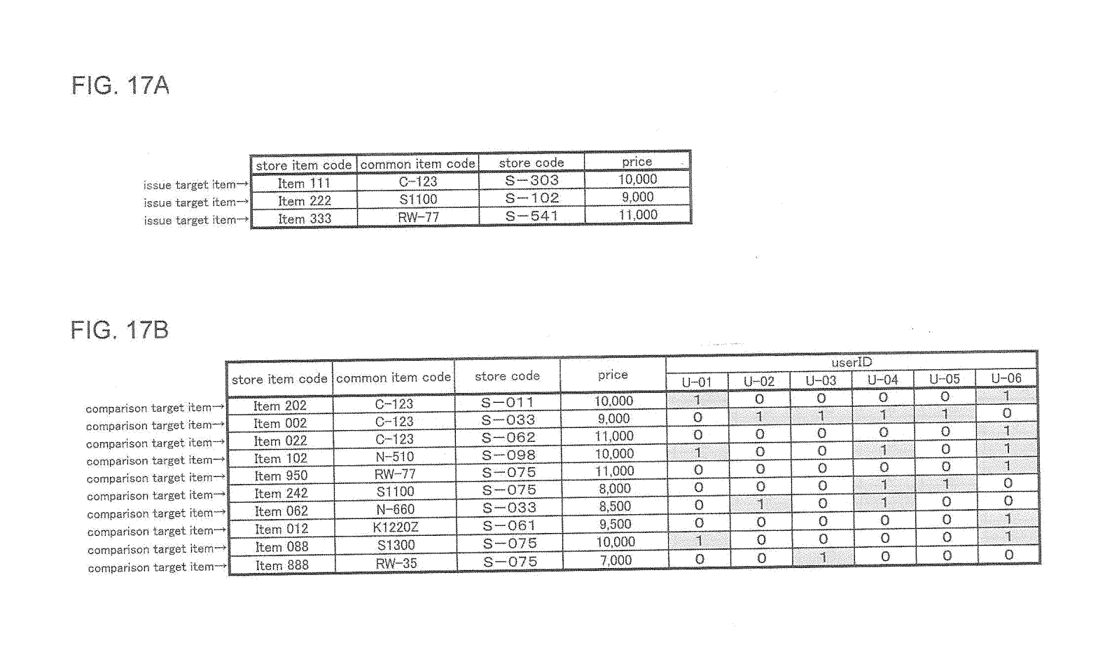

When the process shown in FIG. 16, the system controller 4 (the issue target item identifying unit 41b) identifies items that meet the coupon issue criteria as issue target items for which an electronic coupon is to be issued (Step S71), and stores information such as the store item codes, the common item codes, and the prices of the identified issue target items in a predetermined area of the RAM. For example, if the process shown in FIG. 16 is started because the above condition (I) is met, the system controller 4 identifies, as an issue target item that meets the coupon issue criteria, an item associated with a coupon issue flag of “1” (ON), among the items stored in the item information database 24. On the other hand, for example, if the process shown in FIG. 16 is started because the above condition (II) is met, the system controller 4 identifies, as an issue target item that meets the coupon issue criteria, an item corresponding to a store whose advertising budget is greater than or equal to a predetermined amount (threshold value), among the items stored in the item information database 24. On the other hand, for example, if the process shown in FIG. 16 is started because the above condition (III) is met, the system controller 4 identifies, as an issue target item that meets the coupon issue criteria, an item whose stock quantity is greater than or equal to a predetermined number (threshold value), among the items stored in the item information database 24. On the other hand, for example, if the process shown in FIG. 16 is started because the above condition (IV) is met, the system controller 4 identifies, as an issue target item that meets the coupon issue criteria, an item that was searched for more than a predetermined number of times (threshold value) (e.g., an item whose total number of times per unit period that it was searched for is greater than or equal to the predetermined number), among the items stored in the item information database 24. Alternatively, in this case, the system controller 4 may identify, as an issue target item that meets the coupon issue criteria, an item (what is called, a trend item) whose difference between the increase in the number of times per the current unit period that it was searched for and the past average increase or the increase during the latest period is greater than or equal to a predetermined value (threshold value). The current unit period is, e.g., a unit period (e.g., about twenty-four hours) before the current time. The latest period is, e.g., a unit period before the time twenty-four hours ago. On the other hand, for example, if the process shown in FIG. 16 is started because the above condition (V) is met, the system controller 4 identifies, as an issue target item that meets the coupon issue criteria, an item that was viewed more than a predetermined number of times (threshold value) (e.g., an item whose total number of times per unit period that it was viewed is greater than or equal to the predetermined number), among the items stored in the item information database 24. Alternatively, in this case, the system controller 4 may identify, as an issue target item that meets the coupon issue criteria, an item (what is called, a trend item) whose difference between the increase in the number of times per unit period that it was viewed and the past average increase or the increase during the latest period is greater than or equal to a predetermined value (threshold value). On the other hand, for example, if the process shown in FIG. 16 is started because the above condition (VI) is met, the system controller 4 identifies, as an issue target item that meets the coupon issue criteria, an itemwhose sales is less than (or less than or equal to) a predetermined amount (threshold value), among the items stored in the item information database 24. FIG. 17A is a diagram showing a list of the store item codes, the common item codes, the store codes, and the prices of the issue target items identified in Step S71. In the example of FIG. 17A, three issue target items are identified.

Subsequently, the system controller 4 (the comparison target item identifying unit 41c) performs, for each of the issue target items identified in Step S71, a comparison target item identification process for identifying comparison target items to be compared with the issue target item (Step S72). In Step S72, the same comparison target item identification process (Example 1), (Example 2), or (Example 5) as in the above Step S57 is performed. Comparison target items are thus identified. Next, the system controller 4 (the target user identifying unit 41a) identifies, for each of the comparison target items identified in Step S72, users Un who are interested in the comparison target item as target users to which an electronic coupon is to be issued (e.g., by their user IDs) (Step S73). For example, the system controller 4 searches the user information database 23 for history information (e.g., viewing history) including the store item code of the comparison target item, and identifies the user Un assigned the user ID associated with the retrieved history information as a user Un who is interested in the comparison target item. Based on history information including the store item code of the comparison target item, the system controller 4 may identify a user Un who viewed the comparison target item more than a predetermined number of times (threshold value) as a user Un who is interested in the comparison target item. Even for a user Un whose history information does not include the store item code of the comparison target item, if the store item code of an estimated viewed item identified for each user Un through the estimated viewed item identification processes shown in FIG. 10A and 10B is the same as that of the above comparison target item, the system controller 4 may identify the user Un as a user Un who is interested in the comparison target item. FIG. 17B is a diagram showing the store item codes, the common item codes, the store codes, and the prices of the comparison target items identified in Step S72, and the user IDs of the target users identified for each comparison target item in Step S73. In the example of FIG. 17B, the target users corresponding to the comparison target items are indicated by “1”.

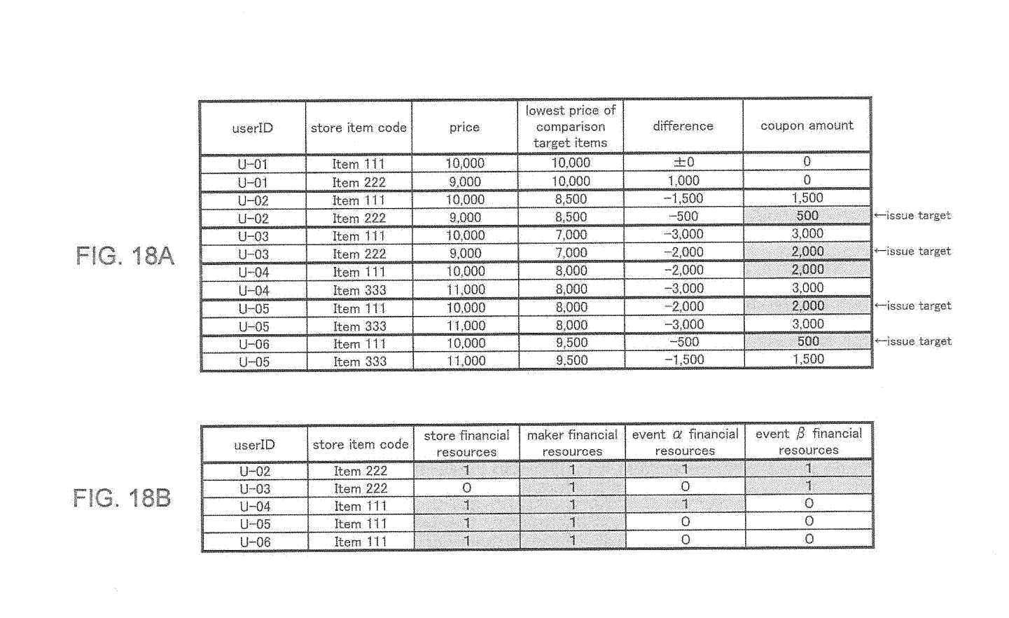

Next, the system controller 4 calculates, for each of the target users identified in Step S73 (or for each target user and each issue target item), the difference between the price of the corresponding issue target item identified in Step S71 and the price (the lowest price, when there are a plurality of comparison target items) of the comparison target item identified as an item to be compared with the issue target item in Step S72 (Step S74). After that, the system controller 4 determines, for each target user (or for each target user and each issue target item), a coupon amount relative to the difference calculated in Step S74 (Step S75). FIG. 18A is a diagram showing a list of coupon amounts, each of which is determined for each target user and each issue target item. In the example of FIG. 18A, a coupon amount is determined for each of two issue target items associated with one target user (e.g., the user whose user ID is U-01). In such a case, however, a coupon amount for either one of the issue target items is finally determined. The purpose is to issue one electronic coupon to one user. It is desirable to finally issue an electronic coupon to the lower coupon amount of the two issue target items.

Subsequently, the system controller 4 (the financial resource identification unit 41h) identifies electronic coupon resources that are available as financial resources for each of the coupon amounts determined in Step S75, in the same manner as in the above Step S62 (Step S76). Next, the system controller 4 identifies, for each target user (or for each target user and each issue target item), electronic coupon resources that are associated with at least either the above issue target item or the above target user, among the electronic coupon resources identified in Step S76, in the same manner as in Step S63 (Step S77). FIG. 18B is a diagram showing a list of electronic coupon resources, each of which is identified for each target user. In the example of FIG. 18B, the electronic coupon resources identified for each target user are indicated by “1”. Steps S78 to S83 are performed for each target user (or for each target user and each issue target issue target item) as in Steps S64 to S69.

As described above, according to the above embodiment, the system controller 4 identifies an item for which an electronic coupon is to be issued and a user to which the electronic coupon is to be issued. The system controller 4 then identifies a plurality of electronic coupon resources that are associated with at least either the identified item or the identified user, among a plurality of electronic coupon resources that are available as financial resources fora value corresponding to a privilege of the electronic coupon. Based on the identified plurality of electronic coupon resources, the system controller 4 determines the allocation of electronic coupon resources to the value corresponding to the privilege of the electronic coupon. The system controller 4 then issues, to the identified user, an electronic coupon indicating the privilege corresponding to the total amount of contributions to be contributed from the electronic coupon resources, based on the determined allocation. Thus, the allocation of electronic coupon resources can be quickly and flexibly determined, depending on an item for which and a user to which an electronic coupon is to be issued.

### REFERENCE SIGNS LIST

1 communication unit
2 storage unit
3 input/output interface unit
4 system controller
MTl maker terminal
STm store terminal
UTn user terminal
SA information providing server

1. An information processing device comprising:
at least one memory configured to store computer program code;
at least one processor configured to read said computer program code and operate as instructed by said computer program code, said computer program code including:
target item identifying code configured to cause at least one of said at least one processor to identify an item for which an electronic coupon is to be issued, the electronic coupon indicating a privilege available in payment for item transactions;
target user identifying code configured to cause at least one of said at least one processor to identify a user to which the electronic coupon is to be issued;
financial resource identifying code configured to cause at least one of said at least one processor to identify a plurality of electronic coupon resources available as financial resources for a value corresponding to a privilege of the electronic coupon, the plurality of electronic coupon resources being associated with at least either the item identified or the user indentified;
determining code configured to cause at least one of said at least one processor to determine, based on the plurality of electronic coupon resources identified, allocation of the electronic coupon resources to the value corresponding to the privilege of the electronic coupon; and
issuing code configured to cause at least one of said at least one processor to issue, to the user identified by the target user identifying means, an electronic coupon indicating the privilege corresponding to a total amount of contributions to be contributed from the electronic coupon resources, based on the allocation determined.

2. The information processing device according to claim 1, wherein
the electronic coupon resources are associated one-to-one with a plurality of providing entities that provide the item identified,
the computer program code further comprising:
user counting code configured to cause at least one of said at least one processor to identify, for each providing entity, the number of potential users of the providing entity; and
calculating code configured to cause at least one of said at least one processor to calculate, for each providing entity, an electronic coupon resource per predetermined unit number of users, based on the number of users of each providing entity identified, the electronic coupon resource remaining after contribution of a predetermined amount, and
the determining code being configured to cause at least one of said at least one processor to preferentially allocate the electronic coupon resources whose electronic coupon resource per the predetermined unit number calculated is relatively large.

3. The information processing device according to claim 1, wherein
the electronic coupon resources are associated one-to-one with a plurality of providing entities that provide the item identified,
the computer program code further comprising:
item counting code configured to cause at least one of said at least one processor to identify, for each providing entity, the number of items whose transactions are expected to be closed, in a stock quantity of the item for which the electronic coupon is to be issued; and
calculating code configured to cause at least one of said at least one processor to calculate, for each providing entity, an electronic coupon resource per predetermined unit number of the items, based on the number of items of each providing entity identified, and
the determining code is configured to cause at least one of said at least one processor to preferentially allocate the electronic coupon resources whose electronic coupon resource per the predetermined unit number calculated is relatively large.

4. The information processing device according to claim 1, wherein
the plurality of electronic coupon resources are each distributed among item categories, and
the determining code is configured to cause at least one of said at least one processor to preferentially allocate the electronic coupon resources having a relatively large amount of electronic coupon resource distributed to an item category to which the item for which the electronic coupon is to be issued belongs.

5. The information processing device according to claim 1, wherein
the plurality of electronic coupon resources are each distributed among predetermined user bases, and
the determining code is configured to cause at least one of said at least one processor to preferentially allocate the electronic coupon resources having a relatively large amount of electronic coupon resource distributed to a user base to which the user to which the electronic coupon is to be issued belongs.

6. The information processing device according to claim 4, wherein
more of the electronic coupon resources are distributed to an item category having a relatively high expectation that item transactions are expected to be closed, among the item categories.

7. The information processing device according to claim 5, wherein
more of the electronic coupon resources are distributed to a user base having a relatively high expectation that item transactions are expected to be closed, among the user bases.

8. The information processing device according to claim 4, wherein
more of the electronic coupon resources are distributed to an item category in which electronic coupons issued in the past are used at a relatively high rate, among the item categories.

9. The information processing device according to claim 5, wherein
more of the electronic coupon resources are distributed to a user base that uses electronic coupons issued in the past at a relatively high rate, among the user bases.

10. The information processing device according to claim 4, wherein
more of the electronic coupon resources are distributed to an item category having a relatively high return on investment based on item prices or discount amounts, among the item categories.

11. The information processing device according to claim 5, wherein
more of the electronic coupon resources are distributed to a user base having a relatively high return on investment based on item prices or discount amounts, among the user bases.

12. An information processing method performed by a computer, the method comprising:
identifying an item for which an electronic coupon is to be issued, the electronic coupon indicating a privilege available in payment for item transactions;
identifying a user to which the electronic coupon is to be issued;
identifying a plurality of electronic coupon resources available as financial resources for a value corresponding to a privilege of the electronic coupon, the plurality of electronic coupon resources being associated with at least either the item identified as a target for which the electronic coupon is to be issued or the user identified as a target to which the electronic coupon is to be issued;
determining, based on the identified plurality of electronic coupon resources, allocation of the electronic coupon resources to the value corresponding to the privilege of the electronic coupon; and
issuing, to the identified user, an electronic coupon indicating the privilege corresponding to a total amount of contributions to be contributed from the electronic coupon resources, based on the determined allocation.

13. A non-transitory recording medium which records an information processing program, the information processing program for causing a computer to: function as:
identify an item for which an electronic coupon is to be issued, the electronic coupon indicating a privilege available in payment for item transactions;
identify a user to which the electronic coupon is to be issued;
identify a plurality of electronic coupon resources available as financial resources for a value corresponding to a privilege of the electronic coupon, the plurality of electronic coupon resources being associated with at least either the item identified or the user identified;
determine, based on the plurality of electronic coupon resources identified, allocation of the electronic coupon resources to the value corresponding to the privilege of the electronic coupon; and
issue, to the user identified, an electronic coupon indicating the privilege corresponding to a total amount of contributions to be contributed from the electronic coupon resources, based on the allocation determined.
